(19) United States
(12) Patent Application Publication
(10) Pub. No.: US 2010/0138673 A1
(43) Pub. Date: Jun. 3, 2010

(54) Method for Secure Storage and Delivery of Media Content

(76) Inventors: Fabrice JOGAND-COULOMB, San Carlos, CA (US); Michael HOLTZMAN, Cupertino, CA (US); Paul McAVOY, San Francisco, CA (US); Po YUAN, San Jose, CA (US); Robert C. CHANG, Danville, CA (US)

Correspondence Address: BRINKS HOFER GILSON & LIONE/SanDisk, P.O. BOX 10395, CHICAGO, IL, 60610, US

(21) Appl. No.: 12/697,001

(22) Filed: Jan. 29, 2010

Related U.S. Application Data
(62) Division of application No. 11/322,812, filed on Dec. 30, 2005.
(60) Provisional application No. 60/715,524, filed on Sep. 8, 2005.

(51) Int. Cl. G06F 12/14; G06F 12/00

(52) U.S. Cl. 713/193; 711/164; 711/E12.001; 711/E12.092

(57) ABSTRACT

The memory device contains control structures that allow media content to be stored securely and distributed in a manner envisioned by the content owner, or service providers involved in the distribution. A wide variety of different avenues become available for distributing media content using such memory devices, such as where the devices contain one or more of the following: abridged preview media content, encrypted unabridged media content, prepaid content, rights and/or rules governing access to such content. The memory device has a type of control structures that enable a service provider (who can also be the content owner) to create a secure environment for media content distribution where end users and terminals register with the service provider, and gain access to the content in a manner controlled by the service provider. The various components to be loaded (e.g. abridged preview media content, encrypted unabridged media content, prepaid content, rights and/or rules governing access to such content) may be generated and loaded in a secure and efficient manner.

### CROSS-REFERENCE TO RELATED APPLICATIONS

This application is a divisional of U.S. patent application Ser. No. 11/322,812, filed Dec. 30, 2005, which claims the benefit of provisional application No. 60/715,524, filed Sep. 8, 2005, both of which applications are hereby incorporated by reference.

### BACKGROUND OF THE INVENTION

This invention is directed to systems that employ mobile storage devices to securely store media content and deliver such content to consumers.

Consumers now use a variety of digital devices to render media content, such as music, video and games. Such devices include cellular phone handsets, personal digital assistants (PDA), desk top, notebook or laptop computers and a variety of media players such as MP3 players, video game machines and so on (collectively also referred to below as terminals). From the end user's point of view, it will be desirable to have no more than one subscription for any media content. In the case of music media content, for example, it will be desirable to have no more than one music subscription and be able to play the music from the subscription through any one of such devices. While mobile network operators (MNO) do allow cellular phone users to access media content through handsets, such content service is typically locked to the handsets, and does not allow the user to access such contents through other terminals in his or her possession.

In the current market environment, companies in the music, movie and video game industries are concerned about unauthorized use of the media content they provide. Because of the ease with which digital files can be copied and transmitted, traditional barriers to unauthorized exploitation of the media content are breaking down and today we witness serious breaches of copyright owned by such companies. Existing media recording and rendering systems, however, still do not provide adequate security to permit end users to be able to render media content using the above described digital devices or terminals in a manner that is entirely satisfactory for the media industry.

It is therefore desirable to provide a mobile memory system and method which can be used to securely store media content and deliver such content only to authorized end users through any of the digital devices or terminals.

### SUMMARY OF THE INVENTION

Non-volatile rewritable memory devices are particularly suitable as a vehicle for storing media content. For example flash memory cards now have capacities in the multi-gigabyte range, which is much higher than other storage media such as smartcards, and can be used to store movies, video games and a large number of music pieces. Furthermore, since flash memory is rewritable, they are more flexible compared to high capacity non-rewritable memories such as compact discs. The one draw back with existing flash memory devices is that they do not provide adequate security to prevent unauthorized use or access to the media content stored on the cards. Thus once media content in non-volatile rewritable memory devices can be securely protected and controlled by or on behalf of the content owner, new avenues for distributing media content will be provided for media companies; the end user will then be able to access the media content in such devices through different mobile digital devices without having to subscribe to multiple media services. Service providers such as MNOs can also derive additional revenue by being able to charge for the service of securely storing media content and distributing media content in a controlled manner.

As one new avenue for distributing media content, in one embodiment, a non-volatile rewritable memory device may be pre-loaded with encrypted media titles so that such titles can be previewed without any restrictions.

In one implementation of the embodiment, such previews may comprise unencrypted portions of the encrypted media titles or unencrypted lower quality versions of such titles. The previews may also comprise a limited number of plays or rendering of the full-length media titles. However, if the end user wishes to access the encrypted media titles without any restrictions or diminution in addition to their previews, the end user will have to purchase the rights to access the encrypted and unabridged media titles. After the end user purchases the right to access the encrypted media titles, he or she will be able to access such titles.

In this implementation of the embodiment, information concerning credentials or other types of authentication information and rights and/or rules for accessing the encrypted media titles that are available for preview are not pre-loaded into the device. These become available to the end user only after the purchase; after the purchase, such information is stored in the memory device.

In an alternative implementation of the embodiment, pre-loaded into the above described non-volatile rewritable memory device are encrypted media titles as well as rights and/or rules which specify that only selected portions of the encrypted media titles or lower quality versions of such titles are accessible without restriction or that such titles can be played for only a limited number of times. After payment by the end user, the rights and/or rules stored in the memory device are then updated to permit access to the encrypted media titles stored in the memory device either without further restriction or with more relaxed restrictions.

Non-volatile rewritable memory devices with security features may also be advantageously used by service providers to control the distribution of media content. Thus as another new avenue for media distribution, non-volatile rewritable memory devices may be provided with security features that enable service providers to create its own secure environment on the device. The service provider can control how the media content stored in the device is to be used in such environment. In one embodiment, the non-volatile rewritable memory device is provided with a system agent which enables the service provider to create a control structure in a secure memory area of the device for controlling access to encrypted content stored in the device. The control structure enables a service provider to set up a scheme for distributing media content in a flexible manner. The control structure can take the form of a hierarchical tree, through which the service provider has many options in controlling how the media content can be used and accessed. The control structure can also take the form of an object referred to below as a “rights object” where rights and/or rules are associated with access to specific media content and with certain authentication requirement(s), where access to such content is granted when such authentication requirement(s) is satisfied. By means of the control structure, a number of applications or end users may be able to access the same content but without sharing keys or credentials, and may be able to delegate the right for access to certain keys used to decrypt and/or encrypt content.

The control structure can also allow the service provider to exercise control over which terminals and accounts may access certain type of content. For example, for a first category of memory devices, the media content in the device can be accessed without restriction through any end user terminal. For a second category of memory devices, these devices with security features can be accessed only by terminals with a particular credential, such as an identifier or ID of a particular service provider (e.g. MNO). Still a third category of memory devices with security features will then enable only a certain group of end users such as a family to access the content in the device by means of terminals having the particular credential, such as the ID of a mobile network operator. Yet a fourth category of the rewritable non-volatile memory devices would enable content stored in the device to be accessed only by a terminal with its own unique credential, together with the particular service provider credential, such as the ID of a mobile network operator.

The control structure created by the service provider or any other entity may be such that it specifies certain permissions for access to one or more content encryption keys used to encrypt media content stored in the non-volatile rewritable memory device. For example, the control structure permits access to the one or more content encryption keys (which may be only for certain specified purposes) when pre-determined credentials are presented to the device. Thus when such a device is operated, the device will determine whether credentials presented to the device are the pre-determined credentials and access to the one or more of the content encryption keys is granted according to permissions for decrypting the encrypted contents when the pre-determined credentials are presented.

A non-volatile rewritable memory device may also enable more than one end user to access encrypted media content stored in the device, but where the different end users may have different rights for accessing the same content, or different content. Thus content visible and accessible to one end user may not be accessible or even visible by a different end user. The device may store control information including information on a plurality of accounts, each associated with a set of encrypted media titles stored in the device, where each account has corresponding credentials. When credentials associated with one account are presented by a host or terminal to the device, the device will check the credentials presented to determine whether encrypted media titles associated with a particular account should be accessible and/or visible. The device will then decrypt the encrypted media titles associated with a particular account and supply the decrypted media titles to the host for rendering when credentials presented by the host are checked to be in order, such as where the presented credentials match those credentials stored in the device for such account. Hence, when no credentials or the wrong credentials are presented by a host or terminal to the device, the encrypted media titles associated with a particular account attempted to be accessed will not even be visible and will not be accessible either. As used in this application, the terms “host” and “terminal” are used interchangeably.

The non-volatile rewritable memory device with security features may be such that each media file stored in the device will have its own content encryption keys or its own credentials required before access to such keys can be granted, and rights and/or rules in regard to how the decrypted media files or titles can be used. In one embodiment, a rights object contains rights and/or rules regarding certain encrypted media content, content encryption keys for decrypting and/or encrypting such content and credentials required for accessing such keys. Such a rights object can be used as a form of the control structure referred to above. Thus, adopting this embodiment of the rights object, the memory device will store a number of content encryption keys available for decrypting a number of corresponding media files stored in the device and store corresponding rights objects. It is possible for each of non-volatile rewritable memory devices manufactured to have unique keys that are different from the keys in any other memory device. This will require a unique set of content encryption keys to be generated for each of the memory devices. Preferably for some applications and for enhanced security, however, the rights object does not contain content encryption keys. Instead it contains the authentication information (e.g. credentials) needed for accessing the content encryption keys. In this manner, an added layer of security is provided.

However, for some applications, it may be desirable to install the same set of content encryption keys (and corresponding rights objects) into each of a batch of non-volatile rewritable memory devices so that different keys do not need to be installed in the different devices in the batch during manufacturing. Each batch of non-volatile rewritable memory devices manufactured will have its own unique group of content encryption keys and corresponding rights objects that are different from those in any other batch of memory devices.

According to this scheme, if a large number of such memory devices are to be manufactured, the devices are divided into a number of groups each having N devices, N being a positive integer. N sets of rights objects each containing a corresponding set of content encryption keys are generated. Each of the N sets of rights objects also has a corresponding set identification code for identifying one device in each of the groups into which such set of rights objects is to be loaded during manufacturing. There are thus N different set identification codes. Each device has a unique identification code, and a set identification code which preferably is derivable from its identification code. Thus during manufacturing, the installation process will first derive the set identification code of each of the devices to be manufactured from its unique identification code. From the set identification code, the corresponding rights object is then identified and loaded to the device. Corresponding media files that can be decrypted using the keys in such rights objects are also loaded to the device. The media files loaded can comprise paid media content as well as unpaid media content that requires payment before it can be accessed, and can comprise previews of such unpaid media content available for unrestricted access.

In an embodiment of yet another aspect of the invention, the media content to be stored in the non-volatile rewritable memory devices is encrypted. This means that the loading of the encrypted media content may be performed at non-secure facilities, which greatly simplifies the manufacturing process of the devices. In one embodiment, for example, rights objects containing content encryption keys may be loaded first into the devices at a secure facility. Thereafter, the devices may then be shipped to non-secure facilities for loading of the encrypted media content the access to which is controlled by the rights object already loaded in the memory devices, and the content encryption keys in the objects then may be used to decrypt the encrypted media contents.

As noted above, non-volatile rewritable memory devices with encrypted media titles and previews of such titles provide new avenue for media content distribution and revenue for media companies. Non-volatile rewritable memories with stored content different from the above type may yet provide other channels of revenue for media companies and other associated providers. In one such configuration, media content is stored in a memory area of the non-volatile rewritable memory card where the content includes only selected and unencrypted portions of at least some media titles or lower quality unencrypted versions of such titles. Such cards may be useful for promotional purposes, and also useful for the end user to preview media content prior to purchase. After the end user has previewed such content, he or she may decide to purchase either the full-length media titles or the high quality versions of such titles. After the purchase, the end user may then download such media titles to the memory device as well as any rights object after payment.

Thus with the above described types of memory devices with preview content, the devices will respond to a request from the end user by rendering the unencrypted portions of the media titles or low quality unencrypted versions of the titles or for a limited duration or number of times. The devices will also query the user as to whether the user wishes to purchase rights to access the full length or high quality versions of the titles. If the preview content is one where the end user can access the full length title a limited number of times, then the memory device will query the end user after accessing the title(s) as to whether the user wishes to purchase rights to unrestricted access of the title(s). In one embodiment, if the user then responds by purchasing such title(s), the appropriate rights objects are then installed and the full length or high quality media title(s) are installed as well if they are not already stored on the device. After such process has been completed, the user may then have the full length or high quality media titles rendered for enjoyment, or can enjoy the titles without any restrictions.

Yet another alternative embodiment is where the non-volatile rewritable memory card stores encrypted media titles without also storing the necessary keys for decrypting the titles. After purchasing the rights for rendering, the end user may then download the appropriate rights objects with the appropriate keys (or credentials for accessing such keys) for decrypting the media titles for enjoyment.

In still another embodiment, a non-volatile rewritable memory card with unencrypted media titles stored therein may be used for market research purposes. Thus also stored in the card are rights object(s) or other control structures that will permit access to the media titles either within a certain time limit or a limited number of times, and the card tracks access to the media titles and compiles an access profile based on the tracked access. The time limit or the number of times by which the media titles can be played or rendered can be extended if the access profile already compiled is downloaded to a server for purposes such as market research.

In still another embodiment, a non-volatile rewritable memory card may store one or more rights object(s) or other control structures as applied to certain encrypted media content that can be accessed but where such content is not stored in a card. Such memory card may be used as a pre-paid media content card available for purchase by end users. Since the content encryption keys (or credentials for accessing such keys) and rights and/or rules are already stored in the card, the end user may be able to download the encrypted content specified under the rights and/or rules in the card and decrypt such content using the one or more content encryption keys that can be accessed by or that is stored in the card for rendering. One advantage of such card is that it permits the end user to repeatedly download encrypted content specified by the rights and/or rules, so that the end user may be able to delete the encrypted content and download the same content at a later time. This permits the user to access a large volume of media content without giving up the right to access such content.

To enable a user to access readily a number of different protected media files without having to provide multiple credentials, the control structures controlling the access to these files allow delegation of the permission or authority to access these files to a another control structure, such as a designated control structure, which permits the user to access all of such media files when a particular set of credentials is presented. In one embodiment, such designated control structure may be a playback access control record or rights object. In another embodiment, the permission delegated is permission for access to keys for decrypting encrypted media files.

In the various embodiments above employing a rights object, the rights object contains keys used for decrypting and/or encrypting the content, and authentication requirements for accessing the keys. Additional embodiments similar to the ones above can be implemented using another embodiment of the rights object where rights and/or rules for accessing certain protected areas of the memory device are associated with corresponding authentication requirements, so that only authorized entities who have complied with such requirements are allowed to access the content stored in such areas. Such embodiment of the rights object may or may not contain keys. Where such embodiment of the rights object contains keys, the keys may be used for decrypting and/or encrypting the content stored in the protected areas or unprotected areas, where compliance with authentication requirements preferably different from those used for accessing the protected areas is needed for accessing the keys.

As noted above, valuable rights and/or content may be loaded to the memory card. For this purpose, it may be important to check the credentials of the card before such valuable content is loaded. Thus according to another aspect of the invention, the credentials of a non-volatile rewritable flash memory card are checked to determine whether the card is genuine or is a counterfeit and information on whether the card is genuine is then provided in response to the checking. This capability may be transferred from one server to another, such as from an authentication server to the service provider server.

In one more embodiment, the rights object is backed up and restored in a manner that prevents one way of circumventing control of content by the rights object. Media content is stored in a first memory area. At least one rights object is stored in a second memory area for controlling access to media content stored in the first memory area. Preferably the second memory area is accessible for backup and restoration of said at least one rights object only by applications that are authorized to do so. In one implementation, the second memory area is a protected partition accessible only by applications with credentials that are different from those used to access the partition for read only functions.

In still another embodiment, a rights object is accessible for read only functions when first credentials are presented to the device and is accessible to be copied, modified or erased when second credentials different from the first credentials are presented to the device. In one implementation, second credentials are presented to the device and the rights object is copied, modified or erased. This process allows the number of copies that can be made of the rights object to be effectively controlled, both in the source memory device from which the rights object is copied and in the recipient device to which the rights object is copied. The total number of copies allowed prior to the copying can be maintained to be the same and not changed by the copying. This can be controlled by either modifying or erasing the rights object in the source memory device and by modifying, if necessary, the rights object prior to copying it to the recipient memory device.

In yet another embodiment, credentials of an application that is accessing a non-volatile rewritable memory card is checked to determine whether it is authorized to do so. An indication that said application is not authorized to accessing the non-volatile rewritable memory card is provided when the credentials of the application does not meet requirements.

The above-described features may be used individually or in any combination to provide different avenues for distributing media content in a secure and controlled manner.

### BRIEF DESCRIPTION OF THE DRAWINGS

FIG. 1 is a block diagram of a memory system in communication with the host device useful for illustrating this invention.

FIG. 2 is a schematic view of different partitions of a memory and of unencrypted and encrypted files stored in different partitions where access to certain partitions and the encrypted files is controlled by access policies and authentication procedures useful to illustrate aspects of the invention.

FIG. 3 is a schematic view of a memory illustrating the different partitions in the memory.

FIG. 4 is a schematic view of file location tables for the different partitions of the memory shown in FIG. 3 where some of the files in the partitions are encrypted.

FIG. 5 is a schematic view of access control records in an access controlled record group and the associated key references which are useful to illustrate aspects of the invention.

FIG. 6 is a schematic view of tree structures formed by access controlled records groups and access controlled records useful to illustrate an aspect of the invention.

FIG. 7 is a schematic diagram of a tree illustrating three hierarchical trees of access controlled record groups to illustrate a process of formation of the trees.

FIGS. 8A and 8B are flow charts illustrating the processes carried out by a host device and a memory device such as a memory card for creating and using a system access control record.

FIG. 9 is a flow chart illustrating a process using a system access control record to create an access controlled record group to illustrate an aspect of the invention.

FIG. 10 is a flow chart illustrating a process for creating an access control record.

FIG. 11 is a schematic view of two access control record groups useful for illustrating a particular application of the hierarchical tree.

FIG. 12 is a flow chart illustrating a process for delegation of specific rights.

FIG. 13 is a schematic view of an access controlled record group and an access control record to illustrate the process of delegation of FIG. 12.

FIG. 14 is a flowchart illustrating the process for creating a key for the purpose of encryption and/or decryption.

FIG. 15 is a flow chart illustrating a process for removing access rights and/or permission for data access according to an accessed controlled record.

FIG. 16 is a flow chart illustrating a process for requesting access when access rights and/or permission to access has been deleted or has expired.

FIGS. 17A and 17B are flow diagrams illustrating sessions of authentication and access when some sessions are open.

FIG. 18 illustrates an environment in which a memory device may be used for storing media content securely and for delivering the media content stored therein in a controlled manner.

FIGS. 19A-19D are flow diagrams illustrating different avenues for media content distribution useful for illustrating various embodiments of the invention.

FIG. 20 is a block diagram of one embodiment of a memory device where different functions are stored in different areas of the device.

FIG. 21 is a block diagram of a system architecture used for implementing the different media content distribution schemes of FIGS. 19A-19D and other figures of this application.

FIG. 22 is a block diagram illustrating a memory device containing paid media content and unpaid catalog media content to illustrate one possible avenue for distributing media contents.

FIGS. 23A-23C are flow charts illustrating a content unlocking process involving the device of FIG. 22.

FIG. 24 is a block diagram illustrating yet another embodiment for unlocking locked catalog media content in the device of FIG. 22 using access control records (ACRs) and a delegation attribute.

FIGS. 25A-25B are flow charts illustrating a process of content rendering.

FIG. 26 is a block diagram of a security architecture or control structure in a non-volatile re-writable memory device to illustrate additional features of this invention.

FIG. 27-32 illustrates an overall architecture for mutual authentication between an end user terminal and a memory device.

FIGS. 33A-35 are flow charts illustrating a process of generating and loading of keys and rights objects for prepaid as well as catalogue content.

FIGS. 36A-36D are schematic diagrams of memory devices with encrypted media titles and previews of such titles to illustrate embodiments of the invention.

FIGS. 37A-37C are schematic diagrams of memory devices with preview content to illustrate further embodiments of the invention.

FIGS. 38A and 38B are schematic diagrams of memory devices with encrypted media titles to illustrate additional embodiments of the invention.

FIGS. 39A and 39B are schematic diagrams of memory devices with rights objects to illustrate more embodiments of the invention.

FIGS. 40-46 are flow charts illustrating processes for distributing media content using the memory devices of FIGS. 36A-39B objects to illustrate embodiments of the invention.

For simplicity in description, identical components are labeled by the same numerals in this application.

### DETAILED DESCRIPTION OF EXEMPLARY EMBODIMENTS

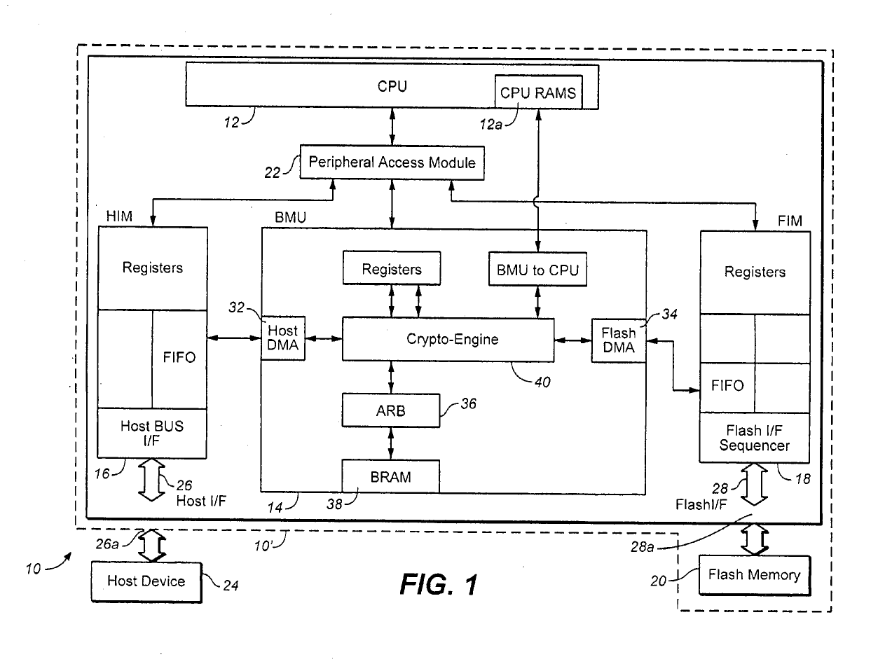

An example memory system in which the various aspects of the present invention may be implemented is illustrated by the block diagram of FIG. 1. As shown in FIG. 1, the memory system or device 10 includes a central processing unit (CPU) 12, a buffer management unit (BMU) 14, a host interface module (HIM) 16 and a flash interface module (FIM) 18, a flash memory 20 and a peripheral access module (PAM) 22. Memory system 10 communicates with a host device 24 through a host interface bus 26 and port 26a. The flash memory 20 which may be of the NAND type, provides data storage for the host device 24. The software code for CPU 12 may also be stored in flash memory 20. FIM 18 connects to the flash memory 20 through a flash interface bus 28 and port 28a. HIM 16 is suitable for connection to a host system like a digital camera, personal computer, personal digital assistants (PDA), digital media players, MP-3 players, cellular telephones or other digital devices. The peripheral access module 22 selects the appropriate controller module such as FIM, HIM and BMU for communication with the CPU 12. In one embodiment, all of the components of system 10 within the dotted line box may be enclosed in a single unit such as in memory card or stick 10′ and preferably encapsulated.

While the invention is illustrated herein by reference to flash memories in the form of cards, the invention may also be applicable to other types of memories whether these are in card form or not, such as magnetic disks, optical CDs, as well as all other types of rewrite-able non volatile memory systems.

The buffer management unit 14 includes a host direct memory access (HDMA) 32, a flash direct memory access (FDMA) 34, an arbiter 36, a buffer random access memory (BRAM) 38 and a crypto-engine 40. The arbiter 36 is a shared bus arbiter so that only one master or initiator (which can be HDMA 32, FDMA 34 or CPU 12) can be active at any time and the slave or target is BRAM 38. The arbiter is responsible for channeling the appropriate initiator request to the BRAM 38. The HDMA 32 and FDMA 34 are responsible for data transported between the HIM 16, FIM 18 and BRAM 38 or the CPU random access memory (CPU RAM) 12a. The operation of the HDMA 32 and of the FDMA 34 are conventional and need not be described in detail herein. The BRAM 38 is used to store data passed between the host device 24 and flash memory 20. The HDMA 32 and FDMA 34 are responsible for transferring the data between HIM 16/FIM 18 and BRAM 38 or the CPU RAM 12a and for indicating sector completion.

For improved security of the content stored in memory 20, memory system 10 generates the key value(s) that are used for encryption and/or decryption. However, encryption and decryption is typically done file by file, since the host device reads and writes data to memory system 10 in the form of files. Like many other types of storage devices, memory device 10 is not aware of files or file systems. While memory 20 does store a file allocation table (FAT) where the logical addresses of the files are identified, the FAT is typically accessed and managed by the host device 24 and not by the controller 12. Therefore, in order to encrypt data in a particular file, the controller 12 will have to rely on the host device to send the logical addresses of the data in the file in memory 20, so that the data of the particular file can be found and encrypted and/or decrypted by system 10 using the key value(s) available only to system 10.

To provide a handle for both the host device 24 and memory system 10 to refer to the same key(s) for cryptographically processing data in files, the host device provides a reference for each of the key values generated by system 10, where such reference may simply be a key ID. Thus, the Host 24 associates each file that is cryptographically processed by system 10 with a key ID, and the system 10 associates each key value that is used to cryptographically process data with a key ID provided by the host. Thus, when the host requests that a file be cryptographically processed, it will send the request along with a key ID along with the logical addresses of data to be fetched from or stored in memory 20 to system 10. System 10 generates a key value and associates the key ID provided by the host 24 with such value, and performs the cryptographic processing. In this manner, no change needs to be made in the manner memory system 10 operates while allowing it to control the cryptographic processing using the key(s). In other words, system 10 continues to allow the host 24 to manage the files by having exclusive control of FAT, while it maintains control for the generation and management of the key value(s) used for cryptographic processing.

The key ID provided by the host 24 and the key value generated by the memory system form two attributes of a quantity referred to below as the “content encryption key” or CEK. While the host 24 may associate each key ID with one or more files, host 24 may also associate each key ID with unorganized data or data organized in any manner, and not limited to data organized into complete files.

In order for a user or application to gain access to protected content or area in system 10, it will need to be authenticated using a credential which is pre-registered with system 10. A credential is tied to the access rights granted to the particular user or application with such credential. In the pre-registration process, system 10 stores a record of the identity and credential of the user or application, and the access rights associated with such identity and credential determined by the user or application and provided through the host 24. After the pre-registration has been completed, when the user or application requests to write data to memory 20, it will need to provide through the host device its identity and credential, a key ID for encrypting the data, and the logical addresses where the encrypted data is to be stored. System 10 generates a key value and associates this value with the key ID provided by the host device, and stores in its record or table for this user or application the key ID for the key value used to encrypt the data to be written. It then encrypts the data and stores the encrypted data at the addresses designated by the host as well as the key value it generated.

When a user or application requests to read encrypted data from memory 20, it will need to prove its identity by providing credentials, provide the key ID for the key previously used to encrypt the requested data, and the logical addresses where the encrypted data is stored. System 10 will then match the user or application identity and credential provided by the host to those stored in its record. If they match, system 10 will then fetch from its memory the key value associated with the key ID provided by the user or application, decrypt the data stored at the addresses designated by the host device using the key value and send the decrypted data to the user or application.

By separating the authentication credentials from the management of keys used for cryptographic processing, it is then possible to share rights to access data without sharing credentials. Thus, a group of users or applications with different credentials can have access to the same keys for accessing the same data, while users outside this group have no access. While all users or applications within a group may have access to the same data, they may still have different rights. Thus, some may have read only access, while others may have write access only, while still others may have both. Since system 10 maintains a record of the users or application identities and credentials, the key IDs they have access to, and the associated access rights to each of the key IDs, it is possible for system 10 to add or delete key IDs and alter access rights associated with such key IDs for particular users or applications, to delegate access rights from one user or application to another, or even to delete or add records or tables for users or applications, all as controlled by a properly authenticated host device. The record stored may specify that a secure channel is required for accessing certain keys. Authentication may be done using symmetric or asymmetric algorithms as well as passwords.

Especially important is the portability of the secured content in the memory system 10. Since the key value is generated by the memory system and substantially not available to external systems, when the memory system or a storage device incorporating the system is transferred from one external system to another, security of the content stored therein is maintained, and external systems are not able to access such content unless they have been authenticated in a manner completely controlled by the memory system. Even after being so authenticated, access is controlled by the memory system, and external systems can access only in a manner controlled according to preset records in the memory system. If a request does not comply with such records, the request will be denied.

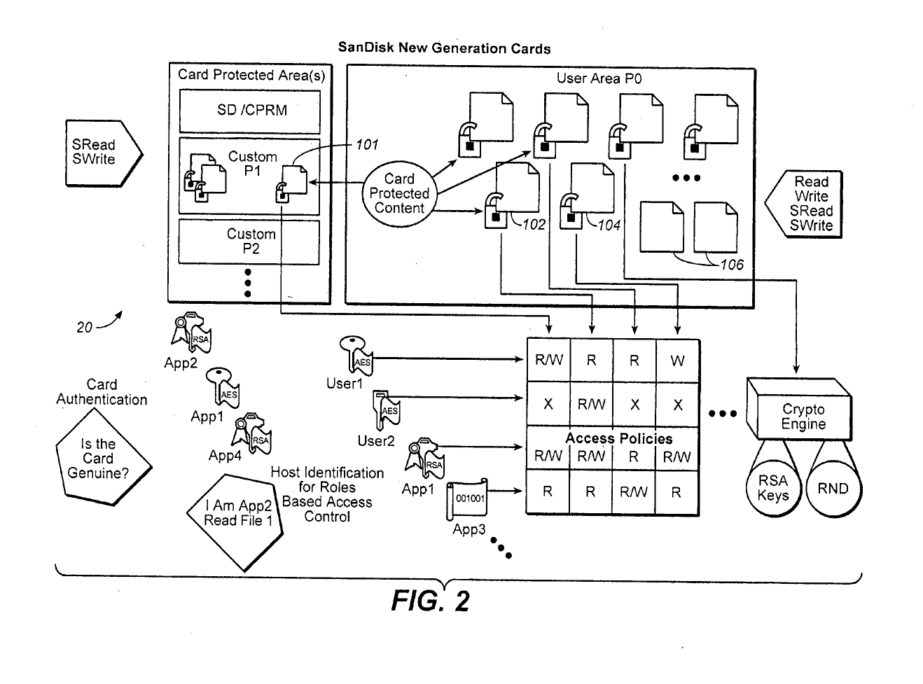

To provide greater flexibility in protecting content, it is envisioned that certain areas of the memory referred to below as partitions can be accessed only by properly authenticated users or applications. When combined with the above-described features of key-based data encryption, system 10 provides greater data protection capability. As shown in FIG. 2, the flash memory 20 may have its storage capacity divided into a number of partitions: a user area or partition and custom partitions. The user area or partition P0 is accessible to all users and applications without authentication. While all bit values of data stored in the user area can be read or written to by any application or user, if the data read is encrypted, the user or application without authority to decrypt would not be able to access the information represented by the bit values stored in a user area. This is illustrated, for example, by files 102 and 104 stored in user area P0. Also stored in the user area are unencrypted files such as 106 which can be read and understood by all applications and users. Thus, symbolically, the files that are encrypted are shown with locks associated with them such as for files 102 and 104.

While an encrypted file in a user area P0 cannot be understood by unauthorized applications or users, such applications or users may still be able to delete or corrupt the file, which may be undesirable for some applications. For this purpose, memory 20 also includes protected custom partitions such as partitions P1 and P2 which cannot be accessed without prior authentication. The authentication process permitted in the embodiments in this application is explained below.

As also illustrated in FIG. 2, a variety of users or applications may access the files in memory 20. Thus users 1 and 2, and applications 1-4 (running on devices) are shown in FIG. 2. Before these entities are allowed to access protected content in memory 20, they are first authenticated by an authentication process in a manner explained below. In this process, the entity that is requesting access needs to be identified at the host side for role based access control. Thus, the entity requesting access first identifies itself by supplying information such as “I am application 2 and I wish to read file 1.” Controller 12 then matches the identity, authentication information and request against the record stored in memory 20 or controller 12. If all requirements are met, access is then granted to such entity. As illustrated in FIG. 2, user 1 is allowed to read and write to file 101 in partition P1, but can only read files 102 and 104 in addition to user 1 having unrestricted rights to read from and write to files 106 in P0. User 2, on the other hand, is not allowed access to file 101 and 104 but has read and write access to file 102. As indicated in FIG. 2, users 1 and 2 have the same login algorithm (AES) while applications 1 and 3 have different login algorithms (e.g. RSA and 001001) which are also different from those of users 1 and 2. Both users 1 and 2 can access files 106 without presenting any credentials and without any restrictions.

The Secure Storage Application (SSA) is a security application in the firmware of the memory system 10, and illustrates an embodiment of the invention, which can be used to implement many of the above-identified features. SSA may be embodied as software or computer code with database stored in the memory 20 or a non-volatile memory (not shown) in CPU 12, and is read into RAM 12a and executed by CPU 12. The acronyms used in reference to the SSA are set forth in the table below:

Definitions, Acronyms & Abbreviations

| | |
|---|---|
| ACR | Access Control Records |
| AGP | ACR Group |
| CBC | Chain Block Cipher |
| CEK | Content Encryption Key |
| ECB | Electronic Codebook |
| ACAM | ACR Attributes Management |
| PCR | Permissions Control Record |
| SSA | Secure Storage Application |
| Entity | Any thing that has real and individual existence (host side) |
| | that logs in the SSA and thus utilizes its functionalities. |

### SSA System Description

Data security, integrity and access control are the major roles of the SSA. The data are files that would otherwise be stored plainly on a mass-storage device of some kind. The SSA system sits atop of the storage system and adds the security layer for the stored host files.

The main task of the SSA is to manage the different rights associated with the stored (and secured) content in the memory. The memory application needs to manage multiple users and content rights to multiple stored content. Host applications from their side, see drives and partitions that are visible to such applications, and file allocation tables (FATs) that manage and portray the locations of the stored files on the storage device.

In this case the storage device uses NAND flash chip divided to partitions, although other mobile storage devices may also be used and are within the scope of this invention. These partitions are continuous threads of logical addresses, where a start and an end address define their boundaries. Restrictions may therefore be imposed on access to hidden partitions, if desired, by means of software (such as software stored in memory 20) that associates such restrictions with the addresses within such boundaries. Partitions are fully recognizable to the SSA by their logical address boundaries that are managed by it. The SSA system uses partitions to physically secure data from unauthorized host applications. To the host, the partitions are a mechanism of defining proprietary spaces in which to store data files. These partitions can either be public, where anyone with access to the storage device can see and be aware of the partition's presence on the device, or private or hidden, where only the selected host applications have access to and are aware of their presence in the storage device.

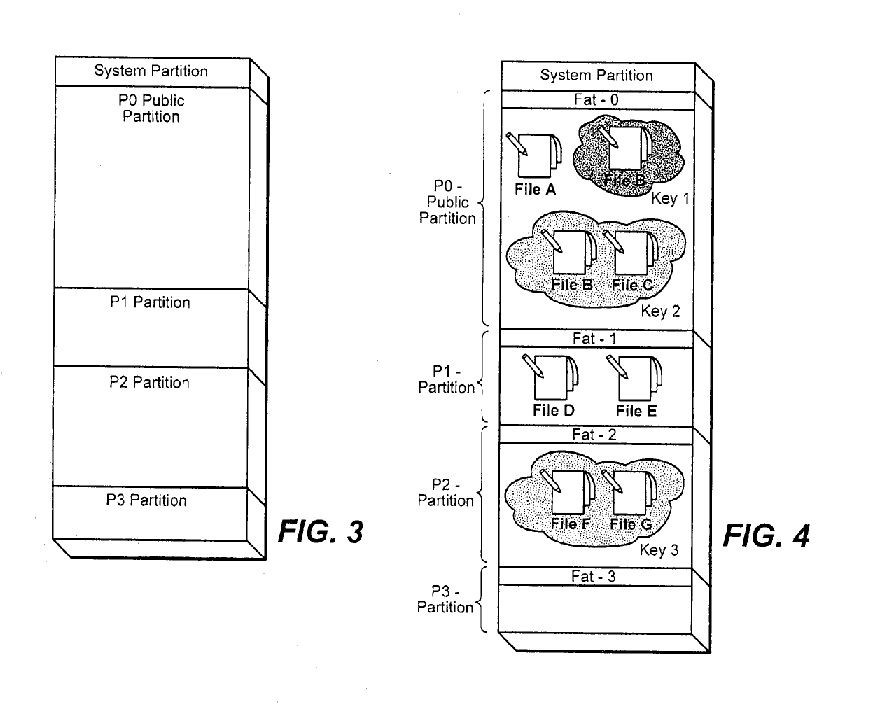

FIG. 3 is a schematic view of a memory illustrating the partitions of the memory: P0, P1, P2 and P3 (obviously fewer or more partitions than four may be employed), where P0 is a public partition which can be accessed by any entity without authentication.

A private partition (such as P1, P2 or P3) hides the access to the files within it. By preventing the host from accessing the partition, the flash device (e.g. flash card) delivers protection of the data files inside the partition. This kind of protection, however, engulfs all of the files residing in the hidden partition by imposing restrictions on access to data stored at the logical addresses within the partition. In other words, the restrictions are associated with a range of logical addresses. All of the users/hosts that have access to that partition will have unlimited access to all of the files inside. To isolate different files from one another—or groups of files—the SSA system provides another level of security and integrity per file—or groups of files—using keys and key references or Key IDs. A key reference or key ID of a particular key value used for encrypting data at different memory addresses can be analogized to a container or domain that contains the encrypted data. For this reason, in FIG. 4, the key references or key IDs (e.g. “key 1” and “key 2”) are shown graphically as areas surrounding the files encrypted using the key values associated with the key IDs.

In reference to FIG. 4, for example, File A is accessible to all entities without any authentication, since it is shown as not enclosed by any key ID. Even though File B in the public partition can be read or overwritten by all entities, it contains data encrypted with a key with ID “key 1”, so that the information contained in File B is not accessible to an entity unless such entity has access to such key. In this manner using key values and key references or Key IDs provide logical protection only, as opposed to the type of protection provided by the partition described above. Hence any host that can access a partition (public or private) is capable of reading or writing the data in the entire partition, including the encrypted data. However, since the data is encrypted, unauthorized users can only corrupt it. They preferably cannot alter the data without detection or use it. By restricting the access to the encryption and/or decryption keys, this feature can allow only the authorized entities to use the data. Files B and C are also encrypted using a key with key ID “key 2” in P0.

Data confidentiality and integrity can be provided through symmetric encryption methods that use Content Encryption Keys (CEK), one per CEK. In the SSA embodiment, the CEKs are generated by the flash device (e.g. flash card), used internally only, and kept as secrets. The data that is encrypted or ciphered may also be either hashed or the cipher is chain block to ensure data integrity. Preferably the CEK are stored in a secure part of the memory not accessible to entities outside the card during normal operations.

Not all the data in the partition is encrypted by different keys and associated with different key IDs. Certain logical addresses either in public or user files or in the operating system area (i.e. FAT) may not be associated with any key or key reference, and thus are available to any entity that can access the partition itself.

An entity that calls for the ability to create keys and partitions as well as writing and reading data from them or using the keys, needs to login to the SSA system through an Access Control Record (ACR). The privileges of an ACR in the SSA system are called Actions. Every ACR may have Permissions to perform Actions of the following three categories: Creating partitions and keys/key IDs, accessing partitions and keys and creating/updating other ACRs.

ACRs are organized in groups called ACR Groups or AGPs. Once an ACR has successfully authenticated, the SSA system opens a Session through which any of the ACR's actions can be executed.

### User Partition(s)

The SSA system manages one or more public partitions, also referred to as the user partition(s). This partition exists on the storage device and is a partition or partitions that can be accessed through the standard read write commands of the storage device. Getting information regarding the size of the partition(s) as well as its existence on the device preferably cannot be hidden from the host system.

The SSA system enables accessing this partition(s) either through the standard read write commands or the SSA commands. Therefore, accessing the partition preferably cannot be restricted to specific ACRs. The SSA system, however, can enable the host devices to restrict the access to the user partition. Read and write accesses can be enabled/disabled individually. All four combinations (e.g. write only, read only (write protect), read and write and no access) are allowed.

The SSA system enables ACRs to associate key IDs with files within the user partition and encrypt individual files using keys associated with such key IDs. Accessing encrypted files within the user partitions as well as setting the access rights to the partitions will be done using the SSA command set (refer to Appendix A for detailed description of the SSA commands—In the Appendix, key ID is referred to as “domain”).

The above features also apply to data not organized into files.

### SSA Partitions

These are hidden (from the host operating system or OS) partitions that can be accessed only through the SSA commands. The SSA system will preferably not allow the host device to access an SSA partition, other than through a session (described below) established by logging onto an ACR. Similarly, preferably the SSA will not provide information regarding the existence, size and access permission of an SSA partition, unless this request is coming through an established session.

Access rights to partitions are derived from the ACR permissions. Once an ACR is logged into the SSA system, it can share the partition with other ACRs (described below). When a partition is created, the host provides a reference name or ID (e.g. P0-P3 in FIGS. 3 and 4) for the partition. This reference is used in further read and write commands to the partition.

### Partitioning of the Storage Device

All available storage capacity of the device is preferably allocated to the user partition and the currently configured SSA partitions. Therefore, any repartition operation may involve reconfiguration of the existing partitions. The net change to the device capacity (sum of sizes of all partitions) will be zero. The IDs of the partitions in the device memory space are defined by the host system.

The host system can either repartition one of the existing partitions into two smaller ones or, merge two existing partitions (which may or may not be adjacent) into one. The data in the divided or merged partitions can be either erased or left untouched, at the host's discretion.

Since repartitioning of the storage device may cause loss of data (either because it was erased or moved around in the logical address space of the storage device) severe restrictions on repartitioning are administered by the SSA system. Only an ACR residing in a root AGP (explained below) is allowed to issue a repartition command and it can only reference partitions owned by it. Since the SSA system is not aware of how data is organized in the partitions (FAT or other file system structure) it is the host's responsibility to reconstruct these structures any time the device is repartitioned.

Repartitioning of the user partition will change the size and other attributes of this partition as seen by the host OS.

After repartitioning, it is the host system's responsibility to make sure any ACR in the SSA system is not referencing the non-existing partitions. If these ACRs are not deleted or updated appropriately, future attempts, on behalf of these ACRs, to access the non-existing partitions will be detected and rejected by the system. Similar care is preferably taken, regarding deleted keys and key IDs.

### Keys, Key IDs and Logical Protection

When a file is written to a certain hidden partition, it is physically hidden from the general public. But, once an entity (hostile or not) gets knowledge and access to this partition the file becomes available and plain to see. To further secure the file, the SSA can encrypt it in the hidden partition, where the credentials for accessing the key for decrypting the file are preferably different from those for accessing the partition. Due to the fact that files are not something that the SSA is aware of (totally controlled and managed by the host), associating a CEK with a file is a problem. Linking the file to something the SSA acknowledges—the key ID, rectifies this. Thus, when a key is created by the SSA, the host associates the key ID for this key with the data encrypted using the key created by the SSA.

The key value and key ID provide logical security. All data associated with a given key ID, regardless of its location, is ciphered with the same content encryption key (CEK) whose reference name or key ID is uniquely provided at creation by the host application. If an entity obtains access to a hidden partition (by authenticating through an ACR) and wishes to either read or write an encrypted file within this partition, it needs to have access to the key ID that is associated with the file. When granting access to the key for this key ID, the SSA loads the key value in CEK associated with this key ID and either decrypts the data before sending it to the host or encrypts the data before writing it to the flash memory 20. A key value in CEK associated with a key ID is randomly created once by the SSA system and maintained by it. The key value is entirely managed by the SSA.

The SSA system protects the data associated with the key ID using any one (user defined) of the following cipher modes (the actual cryptographic algorithms used, as well as the key values in CEKs, are system controlled and not revealed to the outside world):

Block mode—Data is divided into blocks, each one of them, encrypted individually. This mode is generally considered less secure and susceptive to dictionary attacks, However, it will allow users to randomly access any one of the data blocks.

Chained mode—Data is divided into blocks, which are chained during the encryption process. Every block is used as one of the inputs to the encryption process of the next one. This mode, although considered as more secure, requires that the data is always written and read sequentially from start to end, creating an overhead not always acceptable to the users.

Hashed—Chain mode with the additional creation of a data digest that can be used for validating data integrity.

### ACRs and Access Control

The SSA is designed to handle multiple applications where each one of them is represented as a tree of nodes in the system database. Mutual exclusion between the applications is achieved by ensuring no cross talk between the tree branches.

In order to gain access to the SSA system, an entity needs to establish a connection via one of the system's ACRs. Login procedures are administered by the SSA system according to the definitions embedded in the ACR the user chose to connect with.

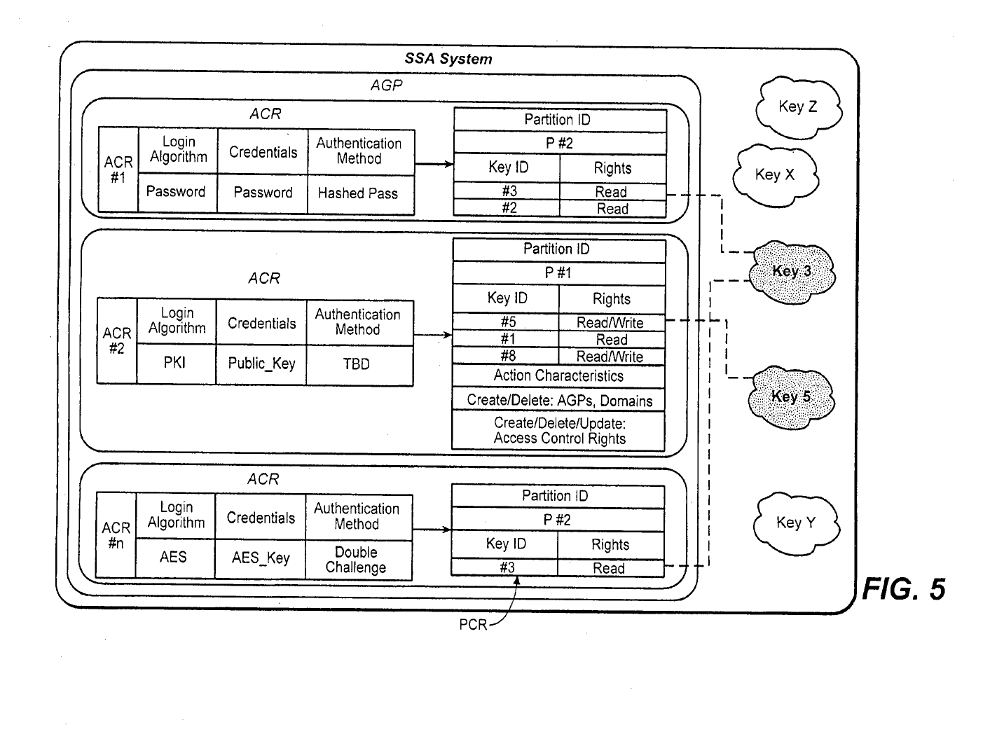

The ACR is an individual login point to the SSA system. The ACR holds the login credentials and the authentication method. Also residing in the record are the login permissions within the SSA system, among which are the read and write privileges. This is illustrated in FIG. 5, which illustrates n ACRs in the same AGP. This means that at least some of the n ACRs may share access to the same key. Thus, ACR #1 and ACR #n share access to a key with key ID “key 3”, where ACR#1 and ACR#n are the ACR IDs, and “key 3” is a key ID for the key that is used to encrypt data associated with “key 3”. The same key can also be used to encrypt and/or decrypt multiple files, or multiple sets of data.

The SSA system supports several types of login onto the system where authentication algorithms and user credentials may vary, as may the user's privileges in the system once he logged in successfully. FIG. 5 again illustrates different login algorithms and credentials. ACR#1 requires a password login algorithm and password as credential whereas ACR#2 requires a PKI (public key infrastructure) login algorithm and public key as credential. Thus, to login, an entity will need to present a valid ACR ID, as well as the correct login algorithm and credential.

Once an entity is logged into an ACR of the SSA system, its permissions—its rights to use SSA commands—are defined in the Permissions Control Record (PCR) which is associated with the ACR. In FIG. 5, ACR#1 grants read only permission to data associated with “key 3”, and ACR #2 grants permission to read and write data associated with “key 5” according to the PCR shown.

Different ACRs may share common interests and privileges in the system such as in keys with which to read and write. To accomplish that, ACRs with something in common are grouped in AGPs—ACR Groups. Thus, ACR #1 and ACR #3 share access to a key with key ID “key 3”.

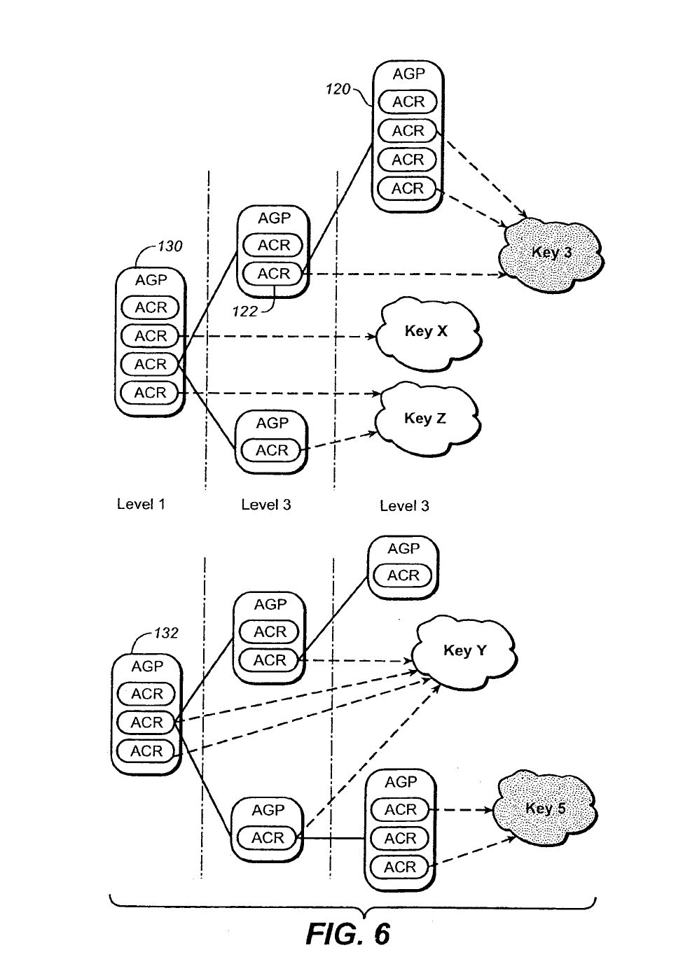

AGPs and, the ACRs within, are organized in hierarchical trees and so aside from creating secure keys that keep sensitive data secure; an ACR can preferably also create other ACR entries that correspond to his key ID/partitions. These ACR children will have the same or less permissions as their father—creator and, may be given permissions for keys the father ACR himself created. Needless to add, the children ACRs get access permissions to any key that they create. This is illustrated in FIG. 6. Thus, all of the ACRs in AGP 120 were created by ACR 122 and two of such ACRs inherit from ACR 122 permission(s) to access to data associated with “key 3”.

### AGP

Logging onto the SSA system is done by specifying an AGP and an ACR within the AGP.

Every AGP has a unique ID (reference name), which is used as an index to its entry in the SSA database. The AGP name is provided to the SSA system, when the AGP is created. If the provided AGP name already exists in the system, the SSA will reject the creation operation.

AGPs are used to administer restrictions on delegation of access and management permissions as will be described in the following sections. One of the functions served by the two trees in FIG. 6 is to administer the access by entirely separate entities, such as two different applications, or two different computer users. For such purposes, it may be important for the two access processes to be substantially independent of one another (i.e. substantially no cross-talk), even though both occur at the same time. This means that the authentication, permissions as well as the creation of additional ACRs and AGPs in each tree are not connected to and do not depend on those of the other tree. Hence, when the SSA system is used in memory 10, this allows the memory system 10 to serve multiple applications simultaneously. It also allows the two applications to access two separate sets of data independently of one another (e.g. a set of photographs and a set of songs). This is illustrated in FIG. 6. Thus, the data associated with “keys 3”, “key X” and “key Z” for the application or user accessing via nodes (ACRs) in the tree in the top portion of FIG. 6 may comprise photographs. The data associated with “key 5” and “key Y” for the application or user accessing via nodes (ACRs) of the tree in the bottom portion of FIG. 6 may comprise songs. The ACR that created the AGP has the permission to delete it preferably only when the AGP is empty of ACR entries.

### The Entity's SSA Entry Point: Access Control Record (ACR)

An ACR in the SSA system describes the way the entity is permitted to log into the system. When an entity logs into the SSA system it needs to specify the ACR that corresponds to the authentication process it is about to perform. An ACR includes a Permissions Control Record (PCR) that illustrates the granted actions the user can execute once authenticated as defined in the ACR illustrated as in FIG. 5. The host side entity provides all of the ACR data fields.

When an entity has successfully logged onto an ACR, the entity will be able to query on all of the ACR's partition and key access permissions and ACAM permissions (explained below).

### ACR ID

When an SSA system entity initiates the login process it needs to specify the ACR ID (as provided by the host when the ACR was created) that corresponds to the login method so that the SSA will set up the correct algorithms and select the correct PCR when all login requirements have been met. The ACR ID is provided to the SSA system when the ACR is created.

### Login/Authentication Algorithm

The authentication algorithm specifies what sort of login procedure will be used by the entity, and what kind of credentials are needed to provide proof of user's identity. The SSA system supports several standard login algorithms, ranging from no procedure (and no credential) and password-based procedures to a two-way authentication protocols based on either symmetric or asymmetric cryptography.

### Credentials

The entity's credentials correspond to the login algorithm and are used by the SSA to verify and authenticate the user. An example for credential can be a password/PIN-number for password authentication, AES-key for AES authentication, etc. The type/format of the credentials (i.e. the PIN, the symmetric key, etc. . . . ) is predefined and derived from the authentication mode; they are provided to the SSA system when the ACR is created. The SSA system has no part in defining, distributing and managing these credentials, with the exception of PKI based authentication where the device (e.g. flash card) can be used to generate the RSA key pair and the public key can be exported for certificate generation.

### The Permissions Control Record (PCR)

The PCR shows what is granted to the entity after logging into the SSA system and passing the ACR's authentication process successfully. There are three types of permission categories: Creation permissions for partition and keys, Access permissions to partitions and keys and management permissions for Entity-ACR Attributes

### Accessing Partitions

This section of the PCR contains the list of partitions (using their IDs as provided to the SSA system) the entity can access upon completing the ACR phase successfully. For each partition the access type may be restricted to write-only or read-only or may specify full write/read access rights. Thus, the ACR#1 in FIG. 5 has access to partition #2 and not partition #1. The restrictions specified in the PCR apply to the SSA partitions and the public partition.

The public partition can be accessed either by regular read and write commands to the device (e.g. flash card) hosting the SSA system, or by SSA commands. When a root ACR (explained below) is created with the permission to restrict the public partition, he can pass it on to his children. An ACR can preferably only restrict the regular read and write commands from accessing the public partition. ACRs in the SSA system can be restricted preferably only upon their creation. Once an ACR has the permission to read/write from/to the public partition, preferably it cannot be taken away.

### Accessing Key IDs

This section of the PCR contains the data associated with the list of key IDs (as provided to the SSA system by the host) the entity can access when the ACR policies have been met by the entity's login process. The key ID specified is associated with a file/files that reside in the partition appearing in the PCR. Since the key IDs are not associated with logical addresses in the device (e.g. flash card), when more than one partition is associated with a specific ACR, the files can be in either one of the partitions. The key IDs specified in the PCR can have each, a different set of access rights. Accessing data pointed to by key IDs can be restricted to write-only or read-only or may specify full write/read access rights.

### ACR Attributes Management (ACAM)

This section describes how in certain cases the ACR's system attributes can be changed.

The ACAM actions that may be permitted in the SSA system are:

Create/delete/update AGPs and ACR.

Create/delete Partitions and Keys.

Delegate access rights to keys and partitions.

A father ACR preferably cannot edit ACAM permissions. This would preferably require the deletion and recreation of the ACR. Also the access permission to a key ID created by the ACR can preferably not be taken away.

### Create/Delete/Update AGPs and ACR

An ACR may have the capacity to create other ACRs and AGPs. Creating ACRs also may mean delegating them some or all of the ACAM permissions possessed by their creator. Having the permission to create ACRs means having the permission for the following actions:

1. Define and edit the child's credentials—the authentication method preferably cannot be edited once set by the creating ACR. The credentials may be altered within the boundary of the authentication algorithm that is already defined for the child.

2. Delete an ACR.

3. Delegate the creating permission to the child ACR (thus having grandchildren).

An ACR with the permissions to create other ACRs has the permission to delegate the unblocking permission to ACRs it creates (although it probably does not have the permission to unblock ACRs). The father ACR will place in the child ACR a reference to his unblocker.

The father ACR is the only ACR that has the permission to delete his child ACR. When an ACR deletes a lower level ACR that he created, then all ACRs spawned by this lower-level ACR are automatically deleted as well. When an ACR is deleted then all the key IDs and partitions that it created are deleted.

There are two exceptions by which an ACR can update its own record:

Passwords/PINs, although set by the creator ACR, can be updated only by the ACR that includes them.

A root ACR may delete itself and the AGP that it resides in.

### Delegate Access Rights to Keys and Partitions

ACRs and their AGPs are assembled in hierarchical trees where the root AGP and the ACRs within are at the top of the tree (e.g. root AGPs 130 and 132 in FIG. 6). There can be several AGP trees in the SSA system though they are totally separated from one another. An ACR within an AGP can delegate access permissions to its keys to all ACRs within the same AGP that it is in, and to all the ACRs created by them. The permission to create keys preferably includes the permission to delegate access permissions to use the keys. The permission to delegate access rights may be stored as an attribute in the permission control record of the corresponding ACR.

Permissions to keys are divided into three categories:

1. Access—this defines the access permissions for the key i.e. Read, Write.

2. Ownership—an ACR that created a key is by definition its owner. This ownership can be delegated from one ACR to another (provided that they are in the same AGP or in a child AGP). An ownership of a key provides the permission to delete it as well as delegate permissions to it.

3. Access Rights Delegation—this permission enables the ACR to delegate the rights he holds.

An ACR can delegate access permissions to partitions he created as well as other partitions he has access permissions to.

The permission delegation is done by adding the names of the partitions and key IDs to the designated ACR's PCR. Delegating key access permissions may either be by the key ID or by stating that access permission is for all of the created keys of the delegating ACR.

### Blocking and Unblocking of ACRs

An ACR may have a blocking counter which increments when the entity's ACR authentication process with the system is unsuccessful. When a certain maximum number (MAX) of unsuccessful authentications is reached, the ACR will be blocked by the SSA system.

The blocked ACR can be unblocked by another ACR, referenced by the blocked ACR. The reference to the unblocking ACR is set by its creator. The unblocking ACR preferably is in the same AGP as the creator of the blocked ACR and has the “unblocking” permission.

No other ACR in the system can unblock the blocked ACR. An ACR may be configured with a blocking counter but without an unblocker ACR. In this case, if this ACR get blocked it cannot be unblocked.

Root AGP—Creating an Application Database

The SSA system is designed to handle multiple applications and isolate the data of each one of them. The tree structure of the AGP system is the main tool used to identify and isolate application specific data. The root AGP is at the tip of an application SSA database tree and adheres to somewhat different behavior rules. Several root AGPs can be configured in the SSA system. Two root AGPs 130 and 132 are shown in FIG. 6. Obviously fewer or more AGPs may be used and are within the scope of this invention.

Registering the device (e.g. flash card) for a new application and/or issue credentials of a new applications for the device are done through the process of adding new AGP/ACR tree to the device.

The SSA system supports three different modes of root AGP creation (as well as all of the ACRs of the root AGP and their permissions):

1. Open: Any user or entity without requiring any sort of authentication, or users/entities authenticated through the system ACR (explained below), can create a new root AGP. The open mode enables creation of root AGPs either without any security measures while all data transfer is done on an open channel (i.e. in the secure environment of an issuance agency) or, through a secure channel established through the system ACR authentication (i.e. Over The Air (OTA) and post issuance procedures).

If the system ACR is not configured (this is an optional feature) and the root AGP creation mode is set to Open, only the open channel option is available.

2. Controlled: Only entities authenticated through the System ACR can create a new root AGP. The SSA system cannot be set to this mode if system ACR is not configured.

3. Locked: Creation of root AGPs is disabled and no additional root AGPs can be added to the system.

Two SSA commands control this feature (these commands are available to any user/entity without authentication):

1. Method configuration command—Used to configure the SSA system to use any one of the three root AGP creation modes. Only the following mode change are allowed: Open->Controlled, Controlled->Locked (i.e. if the SSA system is currently configured as Controlled, it can only be changed to locked)

2. Method configuration lock command—Used to disable the method configuration command and permanently lock the currently selected method.

When a root AGP is created, it is in a special initializing mode that enables the creation and configuration of its ACRs (using the same access restrictions that applied to the creation of the root AGP). At the end of the root AGP configuration process, when the entity explicitly switches it to operating mode, the existing ACRs can no longer be updated and additional ACRs can no longer be created

Once a root AGP is put in standard mode it can be deleted only by logging into the system through one of its ACRs that is assigned with the permission to delete the root AGP. This is another exception of root AGP, in addition to the special initialization mode; it is preferably the only AGP that may contain an ACR with the permission to delete its own AGP, as opposed to AGPs in the next tree level.

The third and last difference between a root ACR and a standard ACR is that it is the only ACR in the system that can have the permission to create and delete partitions.

SSA System ACR

The system ACR may be used for the following two SSA operations:

1. Create an ACR/AGP tree under the protection of a secured channel within hostile environments.

2. Identify and authenticate the device hosting the SSA system.

There may preferably be only one System ACR in the SSA and once defined it preferably cannot be changed. There is no need for system authentication when creating the System ACR; only a SSA command is needed. The create-system-ACR feature can be disabled (similarly to the create-root-AGP feature). After the system ACR is created, the create-system-ACR command has no effect, since preferably only one System ACR is allowed.

While in the process of creating, the System ACR is not operational. Upon finishing, a special command needs to be issued indicating that the System ACR is created and ready to go. After this point the System ACR preferably cannot be updated or replaced.

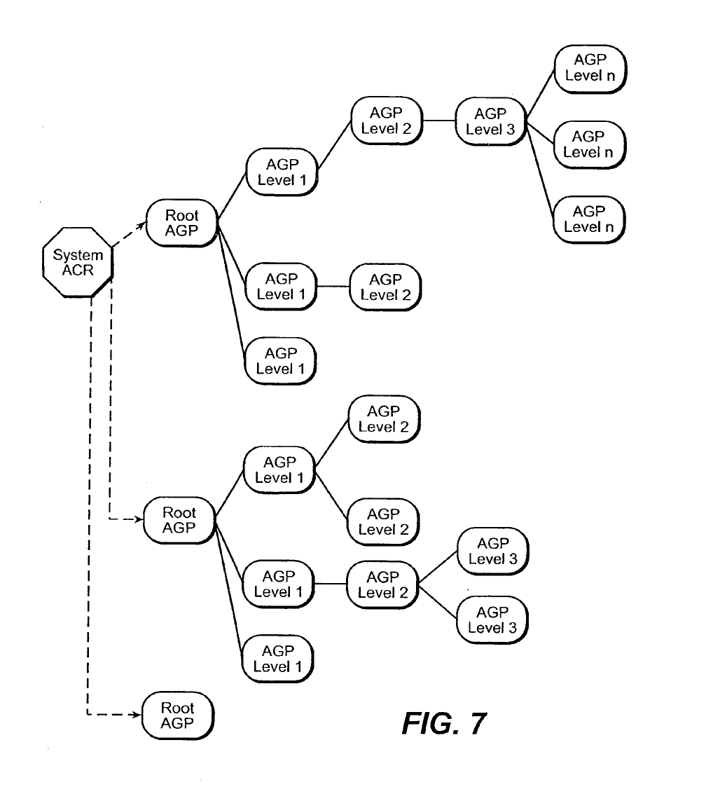

The System ACR creates the root ACR/AGP in the SSA. It has permission to add/change the root level until such time that the host is satisfied with it and blocks it. Blocking the root AGP essentially cuts off its connection to the system ACR and renders it temper proof. At this point no one can change/edit the root AGP and the ACRs within. This is done through an SSA command. Disabling creation of root AGPs has a permanent effect and cannot be reversed. The above features involving the system ACR are illustrated in FIG. 7. The system ACR is used to create three different root AGPs. At a certain time after these are created, the SSA command is sent from the host to block the root AGPs from the system ACR, thereby disabling the create-root-AGP feature, as indicated by the dotted lines connecting the System ACR to the root AGPs in FIG. 7. This renders the three root AGPs temper proof. The three root AGPs may be used to create children AGPs to form three separate trees, before or after the root AGPs are blocked.

The above-described features provides great flexibility to the content owner in configuring secure products with content. Secure products need to be “Issued”. Issuance is the process of putting identification keys by which the device can identify the host and vice versa. Identifying the device (e.g. flash card) enables the host to decide whether it can trust its secrets with it. On the other hand, identifying the host enables the device to enforce security policies (grant and execute a specific host command) only if the host is allowed to.

Products that are designed to serve multiple applications will have several identification keys. The product can be “pre-issued”—keys stored during manufacturing before shipping, or “post issued”—new keys are added after shipping. For post issuance, the memory device (e.g. memory card) needs to contain some kind of master or device level keys which are being used to identify entities which are allowed to add applications to the device.

The above described features enables a product to be configured to enable/disable post issuance. In addition, the post issuance configuration can be securely done after shipping. The device may be bought as a retail product with no keys on it in addition to the master or device level keys described above, and then be configured by the new owner to either enable further post issuance applications or disable them.

Thus, the system ACR feature provides the capability to accomplish the above objectives:

Memory devices with no system ACR will allow unlimited and uncontrolled addition of applications.

Memory devices without system ACR can be configured to disable the system ACR creation, which means there is no way to control adding of new applications (unless the feature of creating new root AGP is disabled as well)

Memory devices with system ACR will allow only controlled addition of applications via a secure channel to establish through an authentication procedure using the system ACR credential.

Memory devices with system ACR may be configured to disable the application adding feature, before or after applications have been added.

### Key ID List

Key IDs are created per specific ACR request; however, in the memory system 10, they are used solely by the SSA system. When a key ID is created the following data is provided by or to the creating ACR:

1. Key ID. The ID is provided by the entity through the host and is used to reference the key and data that is encrypted or decrypted using the key in all further read or write accesses.

2. Key Cipher and data integrity Mode (the Blocked, Chained and Hashed Modes above and as explained below)

In addition to the host provided attributes, the following data is maintained by the SSA system:

1. Key ID Owner. The ID of the ACR that is the owner. When a key ID is created the creator ACR is its owner. Key ID ownership may, however, be transferred to another ACR. Preferably only the key ID owner is allowed to transfer ownership of, and delegate, a key ID. Delegating access permission to the associated key, and revoking these rights can be administered either by the key ID owner or any other ACR assigned with delegation permissions. Whenever an attempt is made to exercise any one of these operations, the SSA system will grant it only if the requesting ACR is authorized.

2. CEK. This is the CEK used to cipher the content associated with or pointed to by the key ID. The CEK may be a 128 bit AES random key generated by the SSA system.

3. MAC and IV values. Dynamic information (message authentication codes and initiation vectors) used in the Chained Block Cipher (CBC) encryption algorithms.

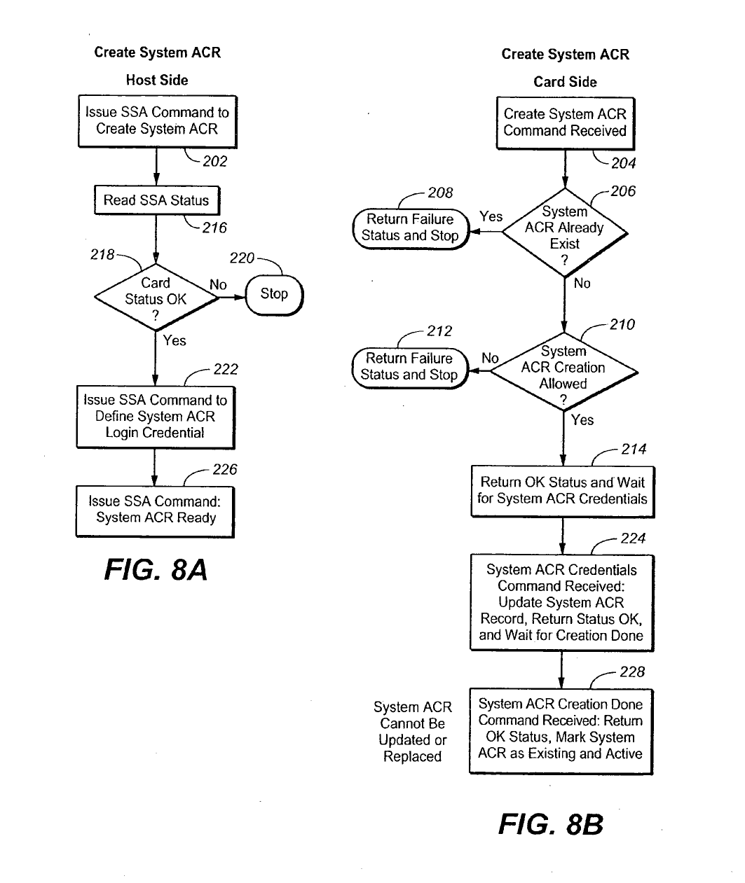

The various features of the SSA are also illustrated in reference to the flow charts in FIGS. 8A-16, where ‘H’ to the left of a step means the operation is performed by the host, and ‘C’ means the operation is performed by the card. In order to create a System ACR, the host issues to the SSA in the memory device 10 a command to create System ACR (block 202). The device 10 responds by checking whether a System ACR already exists (block 204, diamond 206). If it already exists, then device 10 returns failure and stops (oblong 208). If it does not, then memory 10 checks to see if System ACR creation is allowed (diamond 210), and returns a failure status if not allowed (block 212). Thus, there may be instances where the device issuer does not allow the creation of a System ACR, such as in the case where the security features needed have been predetermined so that no System ACR is needed. If this is allowed, the device 10 returns OK status and waits for System ACR credentials from the host (block 214). The host checks the SSA status and whether the device 10 has indicated that the creation of a System ACR is allowed (block 216 and diamond 218). If creation is not allowed or if a system ACR already exists, the host stops (oblong 220). If the device 10 has indicated that the creation of a System ACR is allowed, the host issues a SSA command to define its login credential and sends it to the device 10 (block 222). The device 10 updates a System ACR record with the credential received and returns OK status (block 224). In response to this status signal, the host issues SSA command indicating the system ACR is ready (block 226). The device 10 responds by locking the System ACR so that it cannot be updated or replaced (block 228). This locks in the features of the system ACR and its identity for identifying the device 10 to the host.

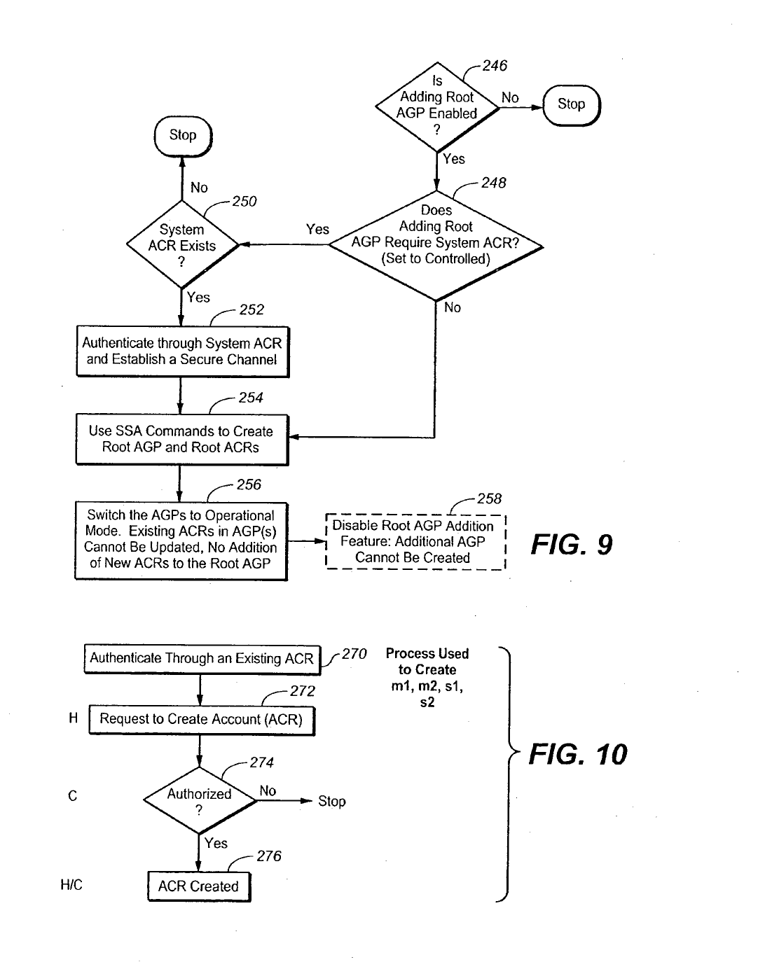

The procedure for creating new trees (New Root AGPs and ACR) is determined by the way these functions are configured in the device. FIG. 9 explains the procedures. Both the host 24 and the memory system 10 follow it. If adding new root AGP is disabled altogether, new root AGPs cannot be added (diamond 246). If it is enabled but requires a system ACR, the host authenticates through the system ACR and establishes a secure channel (diamond 250, block 252) prior to issuing the Create Root AGP command (block 254). If system ACR is not required (diamond 248) the host 24 can issue the create root AGP command without authentication and proceed to block 254. If system ACR does exist, the host may use it even if it is not required (not shown in the flow chart). The device (e.g. flash card) will reject any attempt to create a new root AGP if the function is disabled and it will reject an attempt to create a new root AGP without authentication, if system ACR is required (diamonds 246 and 250). The newly created AGP and ACR in block 254, are now switched to Operational Mode so that the ACRs in such AGPs cannot be updated or otherwise changed, and no ACRs can be added to them (block 256). The system is then, optionally locked so that additional root AGPs cannot be created (block 258). The dotted line box 258 is a convention indicating that this step is an optional step. All the boxes in the flow charts of the figures of this application in dotted lines are optional steps. This allows the content owner to block the use of device 10 for other illicit purposes that may imitate a genuine memory device with legitimate content.

To create ACRs (other than the ACRs in the root AGP as described above), one may start with any ACR that has the right to create an ACR (block 270) as shown in FIG. 10. An entity may attempt to enter through the host 24 by providing the entry point ACR identity, and the ACR with all the necessary attributes that it wishes to create (block 272). The SSA checks for a match to the ACR identity and whether the ACR with such identity has the permission to create an ACR (diamond 274). If the request is verified to be authorized, the SSA in device 10 creates an ACR (block 276).

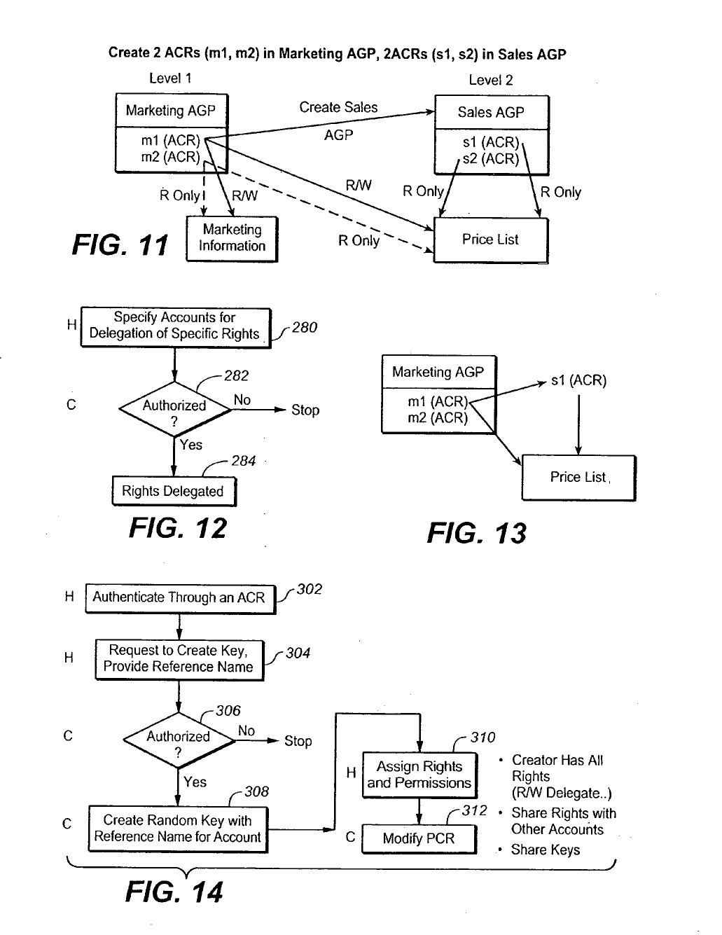

FIG. 11 shows two AGPs that illustrate a tree useful in security applications using the method of FIG. 10. Thus, the ACR with identity m1 in the marketing AGP has the permission to create an ACR. The ACR m1 also has the permission to use a key for reading and writing data associated with the key ID “Marketing Information” and data associated with the key ID “Price List”. Using the method of FIG. 10, it creates the Sales AGP with two ACRs: s1 and s2 with only read permission to the key for accessing pricing data associated with the key ID “Price List”, but not to the key necessary for accessing data associated with the key ID “Marketing Information”. In this manner, the entities with the ACRs s1 and s2 can only read but not change the pricing data, and will have no access to marketing data. The ACR m2, on the other hand, has no permission to create ACRs, and has only read permission to the keys for accessing data associated with the key ID “Price List” and with the key ID “Marketing Information”.

Thus, access rights may be delegated in the manner explained above where m1 delegates rights to read pricing data to s1 and s2. This is particularly useful where large marketing and sales groups are involved. Where there are but one or a few sales people, there may be no need to use the method of FIG. 10. Instead, the access rights may be delegated, by an ACR to one at a lower or the same level within the same AGP, as illustrated in FIG. 12. First, the entity enters the tree for such AGP by specifying an ACR in the manner described above in the tree through the host (block 280). Next the host will specify the ACR and the rights to delegate to. The SSA checks the tree(s) for such ACR and whether the ACR has the permission to delegate rights to the specified another ACR (diamond 282). If it does, the rights are delegated (block 284); if not it stops. The result is illustrated in FIG. 13. The ACR m1 in this case has the permission to delegate read permission to the ACR s1, so that s1 will be able to use a key to access pricing data after the delegation. This may be performed if m1 has the same or greater rights to access pricing data and the permission to so delegate. In one embodiment, m1 retains its access rights after the delegation. Preferably access rights may be delegated under restricted conditions (rather then permanently) such as for a limited time, limited number of accesses, etc.

The process for creating a key and key ID is illustrated in FIG. 14. The entity authenticates through an ACR (block 302). The entity requests the creation of a key with an ID specified by the host (block 304). The SSA checks and see if the ACR specified has the permission to do so (diamond 306). For example, if the key is to be used for accessing data in a particular partition, the SSA will check and see if the ACR may access such partition. If the ACR is authorized, then the memory device 10 creates a key value associated with the key ID provided by the host (block 308), ands stores the key ID in the ACR, and the key value in its memory (either in the controller-associated memory or memory 20) and assigns rights and permissions according to information supplied by the entity (block 310) and modifies the PCR of such ACR with such assigned rights and permissions (block 312). Thus, the creator of the key has all available rights, such as read and write permissions, right to delegate and share with other ACRs in the same AGP or an ACR at a lower level, and the right to transfer ownership of the key.

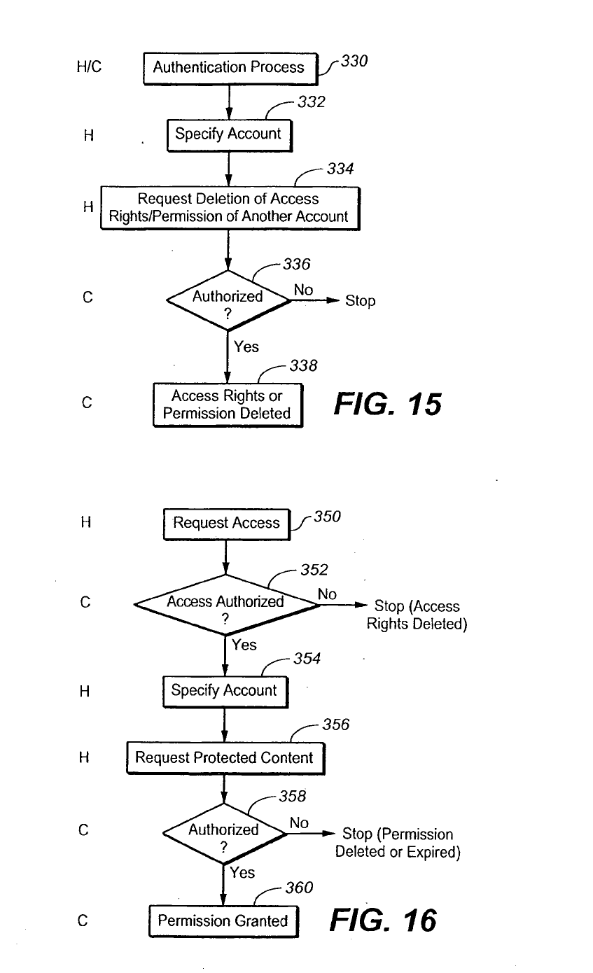

An ACR can change the permissions (or the existence altogether) of another ACR in the SSA system as illustrated in FIG. 15. An entity may enter a tree through an ACR as before; in one case the entity is authenticated and then it specifies an ACR (blocks 330, 332). It requests the deletion of a target ACR or the permission in a target ACR (block 334). If the ACR specified or the one active at such time has the right to do so (diamond 336), the target ACR is deleted, or the PCR of the target ACR is altered to delete such permission (block 338). If this is not authorized the system stops.

After the above-described process, the target will no longer be able to access the data it was able to prior to the process. As shown in FIG. 16, an entity may attempt to enter at the target ACR (block 350) and finds that the authentication process fails, since the previously existing ACR ID is no longer present in the SSA, so that access rights are denied (diamond 352). Assuming that the ACR ID has not been deleted, the entity specifies an ACR (block 354) and the key ID and/or data in a particular partition (block 356), and the SSA then checks to see the key ID or partition access request is permitted according to the PCR of such ACR (diamond 358). If the permission has been deleted or has expired, then the request is again denied. Otherwise, the request is granted (block 360).

The above process describes how access to protected data is managed by the device (e.g. flash card), regardless of whether the ACR and its PCR were just changed by another ACR or were so configured to begin with.

### Sessions

The SSA system is designed to handle multiple users, logged in concurrently. This feature requires that every command received by the SSA is associated with a specific entity and executed only if the ACR, used to authenticate this entity, has the permissions for the requested action.

Multiple entities are supported through the session concept. A session is established during the authentication process and assigned a session-id by the SSA system. The session-id is internally associated with the ACR used for logging into the system and is exported to the entity to be used in all further SSA commands.

The SSA system supports two types of sessions: Open, and Secure sessions. The session type associated with a specific authentication process is defined in the ACR. The SSA system will enforce session establishment in a way similar to the way it enforces the authentication itself. Since the ACR defines the entity permissions, this mechanism enables system designers to associate secure tunneling either with accessing specific key IDs or invoking specific ACR management operations (i.e. creating new ACRs and setting credentials)

### Open Session

Open session is a session identified with a session-id but without bus encryption, all commands and data are passed in the clear. This mode of operation is preferably used in a multi-user or multi-entity environment where the entities are not part of the threat model, nor is eavesdropping on the bus.

Although not protecting the transmission of the data nor enabling efficient fire-walling between the applications on the host side, the Open session mode enables the SSA system to allow access only to the information allowed for the currently authenticated ACRs.

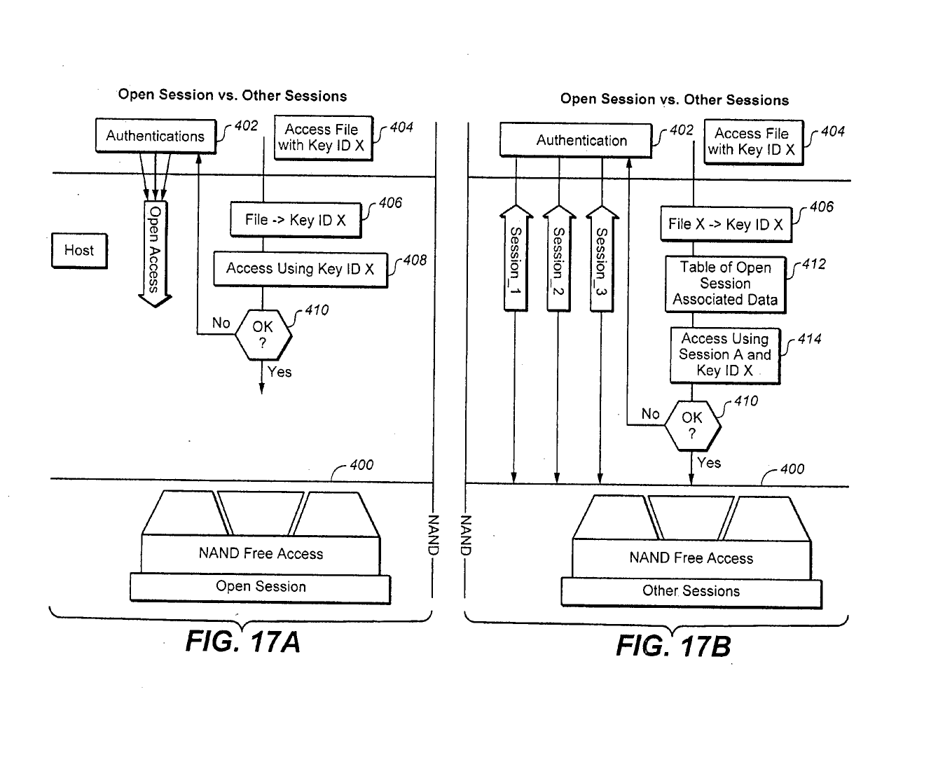

The Open session can also be used for cases where a partition or a key needs to be protected. However, after a valid authentication process, access is granted to all entities on the host. The only thing the various host applications need to share, in order to get the permissions of the authenticated ACR is the session-id. This is illustrated in FIG. 17A. The steps above the line 400 are those taken by the host 24. After an entity is authenticated (block 402) for ACR1, it requests access to a file associated with a key ID X in the memory device 10 (blocks 404, 406 and 408). If the PCR of the ACR 1 allows such access, device 10 grants the request (diamond 410). If not, the system returns to block 402. After authentication is completed, the memory system 10 identifies the entity issuing a command only by the assigned session id (and not the ACR credentials). Once the ACR 1 gains access to the data associated with the key IDs in its PCR, in an open session, any other application or user can access the same data by specifying the correct session ID which is shared between the different applications on the host 24. This feature is advantageous in applications where it is more convenient to the user to be able to log in only once, and be able to access all the data tied to the account through which the log in is performed for different applications. Thus, a cellular phone user may be able to access stored emails, and listen to stored music in memory 20 without having to log in multiple times. On the other hand, data not encompassed by the ACR1 will not be accessible. Thus, the same cellular phone user may have valuable content such as games and photographs accessible through a separate account ACR2. This is data that he does not wish others who borrow his phone to access, even though he may not mind others accessing data available through his first account ACR1. Separating access to the data into two separate accounts while allowing access to ACR1 in open session provides ease of use as well as affording protection of valuable data.

To even further ease the process of sharing the session-id amongst the host applications, when an ACR is requesting an Open session it can specifically request that the session will be assigned the “0 (zero)” id. This way, applications can be designed to use a pre-defined session-id. The only restriction is, for obvious reasons, that only one ACR, requesting session 0 can be authenticated at a specific time. An attempt to authenticate another ACR requesting session 0, will be rejected.

### Secure Session

To add a layer of security, the session id may be used as shown in FIG. 17B. The memory 10 then also stores the session ids of the active sessions. In FIG. 17B, for example, in order to be able to access a file associated with key ID X, the entity will need to also provide a session id, such as session id “A” before it is allowed to access the file (blocks 404, 406, 412 and 414). In this manner, unless the requesting entity is aware of the correct session id, it cannot access the memory 10. Since the session id is deleted after the session is over and will be different for each session, an entity can gain access only when it has been able to provide the session number.

The SSA system has no way to make sure that a command is really coming from the correct authenticated entity, other than by using the session number. For applications and use cases where there is a threat that attackers will try to use an open channel to send malicious commands, the host application uses a secure session (a secure channel).

When using a secure channel, the session-id, as well as the entire command, is encrypted with the secure channel encryption (session) key and the security level is as high as the host side implementation.

### Terminating a Session

A session is terminated and, the ACR is logged off, in any one of the following scenarios:

1. The entity issues an explicit end-session command.

2. Time out on communication. A specific entity issued no command for a time period defined as one of the ACR parameters.

3. All open sessions are terminated after device (e.g. flash card) reset and/or power cycle.

Data Integrity Services

The SSA system verifies the integrity of the SSA database (which contains all the ACRs, PCRs, etc. . . . ). In addition data integrity services are offered for entity data through the key ID mechanism.

If a key ID is configured with Hashed as its encryption algorithms the hash values are stored along side with the CEK and IV in the CEK record. Hash values are calculated and stored during write operation. Hash values are again calculated during read operations and compared with the values stored during the previous write operations. Every time the entity is accessing the key ID the additional data is concatenated (cryptographically) to the old data and the appropriate Hash value (for read or for write) updated.

Since only the host knows the data files associated with or pointed to by a key ID, the host explicitly manages several aspects of the data integrity function in the following manner:

1. A data file associated with or pointed to by a key ID is written or read from the beginning to end. Any attempt to access portions of the file will mess it up since the SSA system is using a CBC encryption method and generates a hashed message digest of the entire data

2. There is no need to process the data in a contiguous stream (the data stream can be interleaved with data streams of other key Ids and may be split over multiple sessions) since intermediate Hash values are maintained by the SSA system. However, the entity will need to explicitly instruct the SSA system to reset the Hash values if the data stream is restarted.

3. When a read operation is completed, the host must explicitly request the SSA system to validate the read Hash by comparing it with the Hash value calculated during the write operation.

4. The SSA system provides a “dummy read” operation as well. This feature will stream the data through the encryption engines but will not send it out to the host. This feature can be used to verify data integrity before it is actually read out of the device (e.g. flash card).

### Random Number Generation

The SSA system will enable external entities to make use of the internal random number generator and request random numbers to be used outside of the SSA system. This service is available to any host and does not require authentication.

RSA Key Pair Generation

The SSA system will enable external users to make use of the internal RSA key pair generation feature and request an RSA key pair to be used outside of the SSA system. This service is available to any host and does not require authentication.

The above detailed description of the SSA system and associated features is essentially taken from U.S. Provisional Patent Application Ser. No. 60/638,804, filed Dec. 21, 2004.

### Avenues for Distributing Media Content

### The Environment and Different Distribution Models

FIG. 18 illustrates an environment in which the above-described memory device 10 may be used for storing media content securely and for delivering the media content stored therein in a controlled manner. As shown in FIG. 18, the media content in device 10 may be rendered by a variety of different end user terminals or hosts, including personal digital assistants, video game machines, cellular telephone handsets 502, media players such as MP3 players 506, and computers 508 such as desktop, notebook, or laptop computers. New avenues for media content distribution may be achieved using device 10 by service providers such as MNOs 504. MNO 504 may supply media content to device 10 through handsets 502. Alternatively, where access to media content stored in device 10 is restricted, rights and/or rules may be downloaded from operator 504 to handsets 502 in order to access the media contents stored in device 10. The rights and/or rules governing access to the encrypted media content in device 10 could also apply even when the media content in device 10 is accessed not by handsets 502, but by other types of terminals such as media player 506 and computer 508. Instead of receiving media content and rights and/or rules from operator 504, device 10 may instead receive such content and rights and/or rules through other servers such as the account management server 510 and computer 508 through the interne. Such content and rights and/or rules may be provided to computer 508 and server 510 by operator 504.

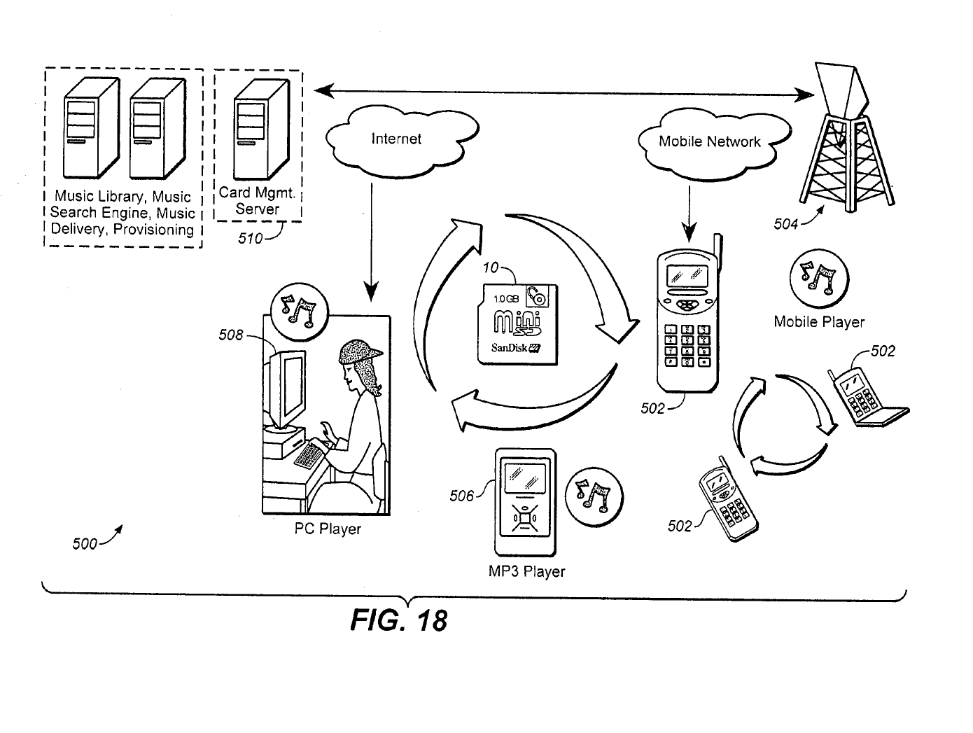

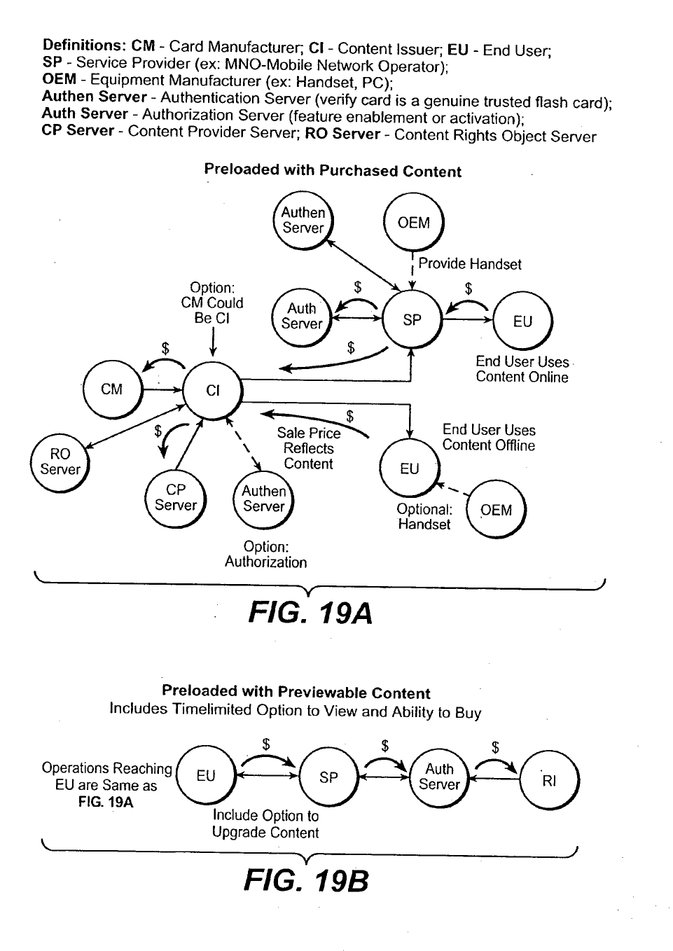

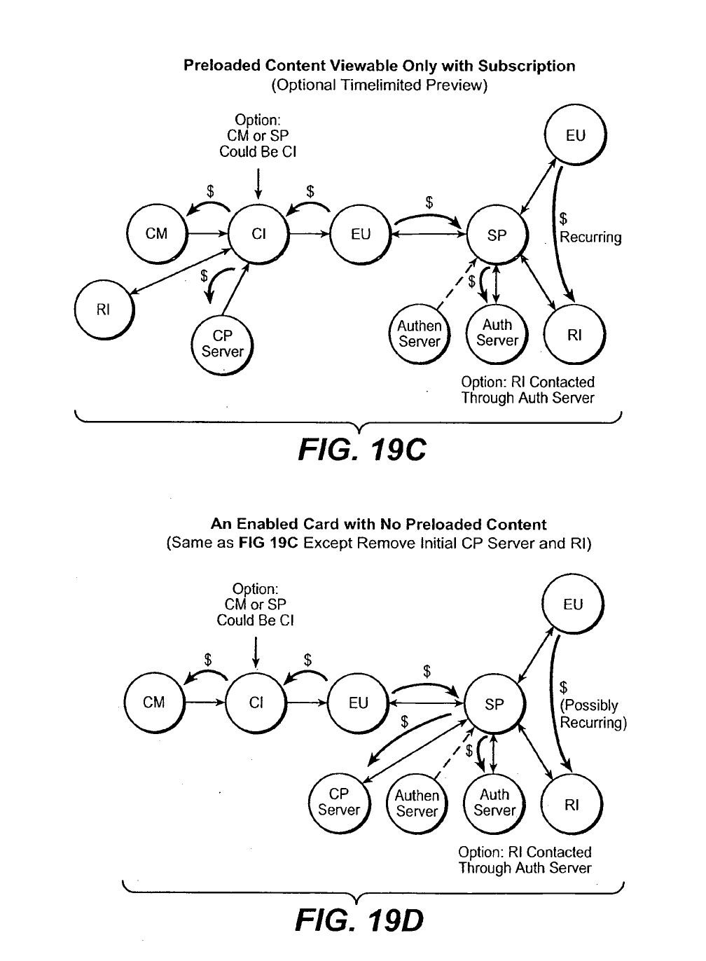

In the environment of FIG. 18, a number of new avenues using memory system or device 10 as the vehicle for storing and distributing media content becomes possible. This is illustrated in FIGS. 19A-19D. An avenue for distributing media content using a memory device pre-loaded with purchased content is illustrated in FIG. 19A. While a flash memory card is used as the example in FIGS. 19A-19D, it will be understood that the same considerations will apply to formats other than cards and other types of non-volatile rewritable memories as well. Thus a flash memory card manufacturer CM sells the card to a Content Issuer CI, who also buys media content from a content provider CP and receives the rights object(s) for controlling such content from a rights objects (RO) server. Before such content and rights object(s) are loaded to the card, the CI first verifies whether the card is genuine by connection to an authentication server. The content and rights object(s) are loaded after the card has been verified to be genuine.

As will be noted from FIG. 19A, the arrow pointing from the Content Issuer (CI) has two branches: one pointing upwards to the Service Provider SP and the lower arrow pointing to the End User EU. The CI sells the card with content either directly to the end user EU along the lower arrow between CI and EU in FIG. 19A, or to a service provider SP along the upper arrow between CI and SP. The transaction along the upper arrow will now be described.

Thus, the Content Issuer, which may also be card manufacturer CM, sells the card to the Service Provider, such as a MNO. The Service Provider then sells the card together with an End User terminal such as a cellular phone handset provided by an Original Equipment Manufacturer (referred to hereinafter as “OEM”) to an End User. In FIGS. 19A-19D, an arrow with a dollar sign next to it indicates a possible flow of revenue between the parties along the direction of the arrow shown in the figures. Before the Content Issuer sells the card to the Service Provider, the Content Issuer may install control structures of the type described herein. Preferably, however, such control structures are installed by the Service Provider as described below to enable the Service Provider to create its own secure environment so that it can control content distribution in the way it deems fit. Before this happens, the card is again verified to be genuine. Thus at the Service Provider's facility, the card is again authenticated by connecting to the authentication server. The card is also connected via a terminal to an authorization server to enable or activate any particular features or applications (e.g. media content rendering applications such as media players) in the card. The Service Provider then installs a control structure of the type described below to control access to the content in the card. The control structure will ensure that only authorized users may be able to access the content, and such access will comply with certain permissions in the control structure or with certain rights and/or rules.

Alternatively, as indicated by the lower arrow pointing from the Content Issuer to the End User, the Content Issuer may sell the card directly to the End User. The End User obtains a terminal such as a cellular phone handset from an OEM. Provided that such terminal and the card can mutually authenticate, such as in a manner described below, the End User will then be able to access the content in the card using the terminal. One process of mutual authentication is explained below.

The above avenue for media distribution is one where the card contains only content already purchased by the End User. In this configuration, the End User is provided with the required authentication information such as credentials for accessing the content. This will prevent others who are not provided with such authentication means to access the content in an unauthorized manner.

FIG. 19B is a flow diagram illustrating another avenue for media content distribution to illustrate another embodiment of the invention. The steps whereby content is installed in the card and by which the card reaches the End User are similar to those in FIG. 19A. The scheme in FIG. 19B differs from that of FIG. 19A in that the content loaded into the card can only be rendered with certain restrictions for preview purposes (e.g. accessing for rendering a portion or lower quality version of the content, or only for limited number of times or duration), instead of being able to render with no restrictions as in the scheme of FIG. 19A. In other words, if the End User wishes to enjoy the media content fully, he or she will have to first purchase the right to access and render unabridged versions of such media content without restrictions instead of being content with their previews. Thus after the purchase, the End User may then access and render without restrictions the full unabridged versions of the media content from the Service Provider. Before the End User is allowed to download the appropriate rights for such purpose, however, the card is again verified to be genuine by means of the authentication server. After such authentication, the Rights Issuer then provides the control structure such as a rights object to the Service Provider, who in turn provides the same to the End User for downloading. In one embodiment, the rights object may comprise credentials for the End User (or other entities such as applications on hosts) to access encrypted media content, and rights and/or rules governing such access. In a different embodiment, the rights object may contain the actual content encryption keys that can be used to decrypt the encrypted media content. Where the rights object contains the actual content encryption keys, the credentials in the rights object may be ones that are generated on the fly using a secret code and the memory device ID as seed values by means of a function such as a hash function. This scheme can also be applied even where the rights object does not contain the actual content encryption keys. The End User may also have the option to upgrade the preloaded content during the purchase, such as by downloading the high quality unabridged version of the preview content.

Alternatively, where preview content is loaded to the card by the Content Issuer in the manner illustrated in FIG. 19A, such content may also include encrypted unabridged versions of the media content. Thus when the End User purchases such cards, the cards will have already stored the encrypted versions of the media content he or she wishes to purchase. The cards will also have stored therein rights and/or rules that restrict the end users rights to access only the abridged versions or portions of the content in the cards. In such circumstances, there is no need to download such content to the card again. Instead, all the End User will need are the content encryption keys for decrypting the media content and an update to the rights and/or rules governing such access to permit unrestricted or more relaxed access. Such information will be downloaded from the Rights Issuer through the Service Provider after authentication.

FIG. 19C is a flow diagram illustrating yet another avenue for media content distribution. A comparison of FIGS. 19A and 19C will reveal that the two schemes are substantially the same, except that in the scheme of FIG. 19C, the content in the card can be accessed by the End User only after the End User subscribes to a service, such as a service provided by the Service Provider. Thus the card purchased by the End User will contain control information which does not allow the End User to access the content until the End User has subscribed. As shown in FIG. 19C, the End User may first purchase the card from the Content Issuer, but will not be able to access the media content therein until he or she has purchased a subscription from the Service Provider. As before, prior to the confirmation of the subscription, the card in the End User's possession is verified to be genuine by the authentication server and the applications (e.g. media content rendering applications such as media players) therein optionally enabled or activated by the authorization server. In the subscription process, the rights object provided by the Rights Issuer is then transmitted by the Service Provider to the End User for downloading to the card. Since the transaction is subscription based, the End User will need to pay for the subscription periodically so that the flow of revenue will be recurring from the End User to the Rights Issuer through the Service Provider.

FIG. 19D is a flow diagram illustrating another avenue for media content distribution. In this scheme, the card purchased by the End User will have no pre-loaded media content. Thus the End User will have to purchase the content from the Service Provider who in turn obtains content from the content provider server. As before, prior to the loading of the content to the card, the card is authenticated by the authentication server. Features and applications (e.g. media content rendering applications such as media players) are optionally enabled by the authorization server. As part of the transaction, a rights object originating from the Rights Issuer is transmitted through the Service Provider to the End User for download to the card. This transaction may be subscription based so that the End User will have to periodically pay the Rights Issuer and the Service Provider. While the card purchased by the End User may have no pre-loaded media content, the card may have rights object(s) stored therein which entitle the End User to download such content. This is then a prepaid media content card, which enables the End User to repeatedly download content purchased.

### Different Modules and Functions of Device 10

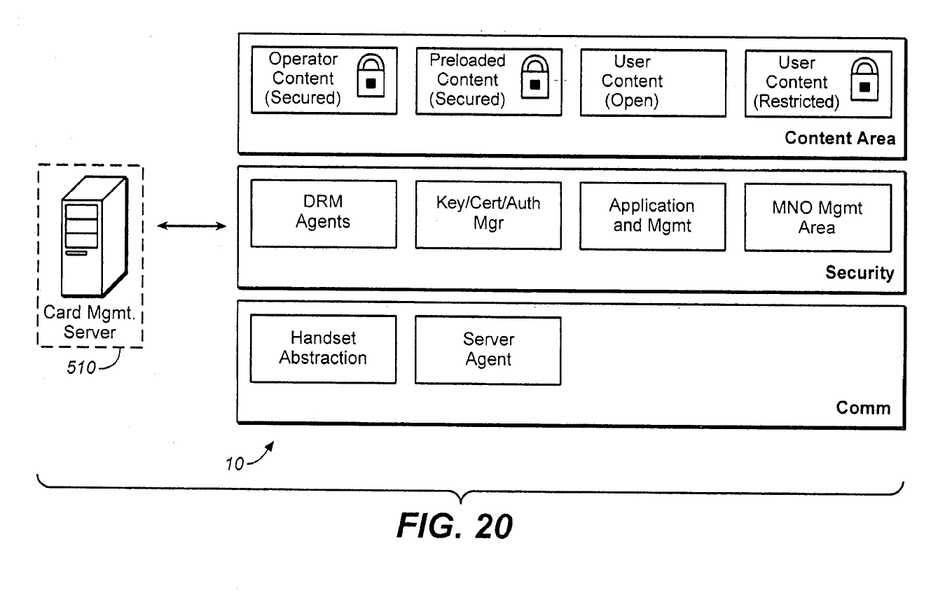

FIG. 20 is a block diagram of one embodiment of memory device 10 where different functions are stored in different areas of the device. As shown in FIG. 20, device 10 has a content area which stores secured operator content, such as encrypted content associated or owned by an MNO, such as operator 504 of FIG. 18. Stored in the content area is also encrypted and/or unencrypted preloaded content described in more detail below. Also stored in the content area may be user content that is not restricted, as well as user content that is restricted and locked, such as by means of encryption.

Security area of device 10 may contain a number of different functions implemented by software codes, such as the DRM agents described in more detail below. Security area of device 10 may be implemented using the hidden partitions described above. Content encryption keys, certificates, and an authorization manager may also be stored in the security area. Control structures such as AGP/ACR described above may form part of the authorization manager. Also stored in the security area are applications and management structures for MNO operators. In a communications area, device 10 stores a handset abstraction and server agent. These may be useful where device 10 is operated by a handset.

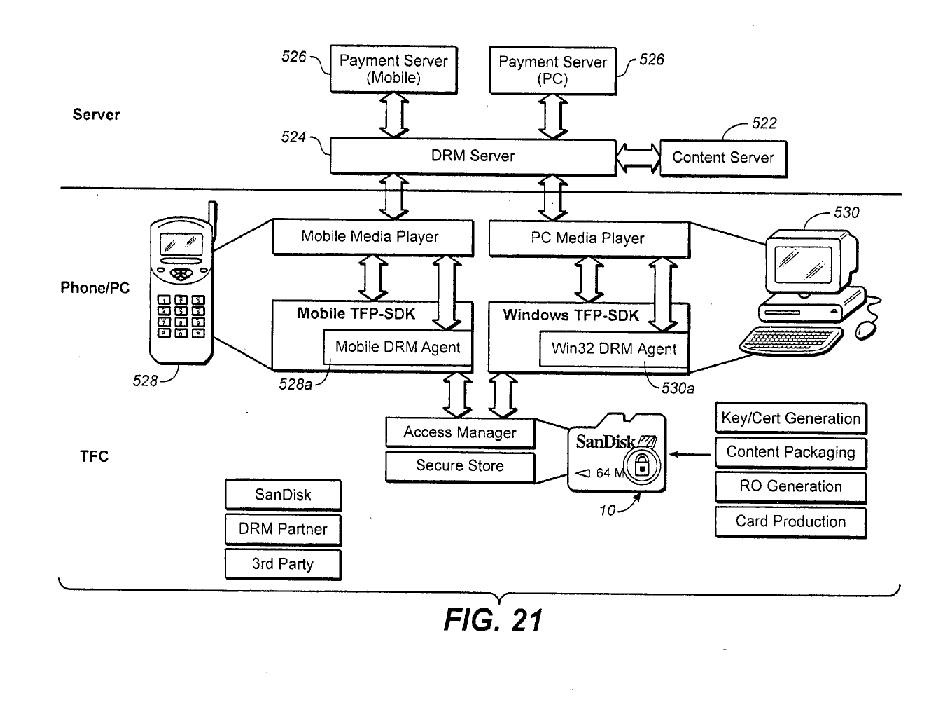

FIG. 21 is a block diagram of a system architecture used for implementing the different media content distribution schemes of FIGS. 19A-19D. As shown in FIG. 21, memory device 10 comprises a secure store which preferably utilizes the above-described features of hidden partitions and encryption using content encryption keys with access control records (ACRs) or rights objects (“RO”) as possible embodiments. Device 10 also includes an access manager (which can include or be a part of the DRM agent stored in the security area of the device), which can interface with different digital rights management (DRM) agents now in use commercially. These include, for example, mobile DRM agents commonly used in handsets for cellular phones and the Windows 32 DRM agent now commonly used on personal computers. In this manner, the access manager of device 10 can interface with different types of DRM agents in the End User terminals for the purpose of downloading content and rights objects (or updating rights objects) as well as altering the permissions in the access control records or rights objects in device 10.

Thus when media content is to be downloaded from the SP server in FIGS. 19A-19D to device 10, the architecture of FIG. 21 implements such download by first passing the media content from the content server 522 to the DRM server 524. The content server 522 may be situated at a Service Provider which receives the content from the content provider server. Alternatively, if the media content is downloaded from the content provider directly without going through the Service Provider, the content server 522 may be located at a content provider's facility. DRM server 524 is in communication with payment servers 526 which manage payment to the MNOs and other entities for media content downloads through handsets, personal computers and other terminals as described above in reference to FIGS. 18 and 19A-19D. Thus after proof of payment is provided by one of the multiple payment servers 526, the DRM server 524 transmits rights objects and the media content from content server 522 to a terminal (handset 528 or personal computer 530 in FIG. 21). The DRM agent 528a or 530a then transmits the media content and rights objects to the access manager of device 10 where the access manager then stores such media content in a partition in device 10. The rights objects may be obtained by server 524 from the Rights Issuer not shown in FIG. 21. Instead of transmitting rights objects as described above, the DRM agents and the access manager may alter or update rights objects (e.g. after purchase of new or additional rights) already stored in device 10. The installation and alteration of control structures such as ACRs, AGPs and ROs may be performed in a similar manner. The processes described herein where media content and rights objects are transmitted or altered are preferably performed via a secure session of the type described above using a session key. Thus, the credentials or other authentication information as well as decrypted media files may be encrypted with session keys before they are transmitted. This is true also where other types of control structures such as ACRs, AGPs and hierarchical trees are created or altered in the memory device through a terminal in communication with a server.

As illustrated more clearly in FIG. 20, the access manager in device 10 includes a DRM agent which is able to interface and directly handle commands from DRM server 524, so that even if the End User terminals, such as handset 528 and computer 530, do not include a DRM agent, the access manager of device 10 will still be able to implement the above-described functions, such as the installation or alteration of control structures and the downloading of media content and rights objects.

Memory Device with Preview Content

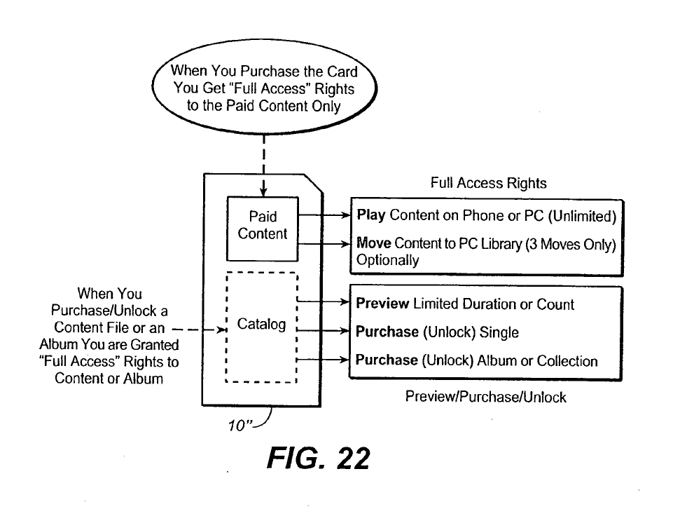

FIG. 22 is a block diagram illustrating a memory device containing paid media content and unpaid catalog media content to illustrate one possible avenue for distributing media contents. As illustrated above in reference to FIG. 19A, content including paid media content and unpaid catalog media content may be loaded into the memory device 10 so that the memory device containing such content is labeled 10″ in FIG. 22. Also loaded into the memory device is a corresponding rights object for controlling access to the paid content. As illustrated in FIG. 22, in one implementation, the rights object permits unlimited access to the paid content via a terminal such as a cellular phone handset or personal computer, but only permits moving the content to a personal computer library three times, which may be an optional feature. Alternatively, the optional feature may be that whoever has the appropriate credentials will be able to export the paid media content by means of a software application operating in the terminal to other terminals for storage for only up to three times.

In regard to the catalog media content, however, the purchase of device 10″ does not permit the purchaser to have full rights to the catalog media contents. Instead, the purchaser's rights can be limited or abridged in a number of different ways. For example, as indicated in FIG. 22, the right to preview the catalog media content may be limited by time duration or by the number of times or count. Alternatively, only a selected portion (e.g., 15 seconds of a song or video) of the media title can be accessed without restriction, or what can be accessed is only a lower quality version. Thus in order to obtain unrestricted access to the unabridged full quality media titles cataloged, the purchaser will need to first purchase such rights. The rights purchased can be to a single media content file or an entire album of content files. In the embodiment illustrated in FIG. 22, the full unabridged versions of the media titles cataloged are actually stored in device 10″ but are encrypted so that the purchasers would not be able to access the full unabridged versions of the media titles. After purchase, the media content file that is purchased is then unlocked to permit access by the purchaser.

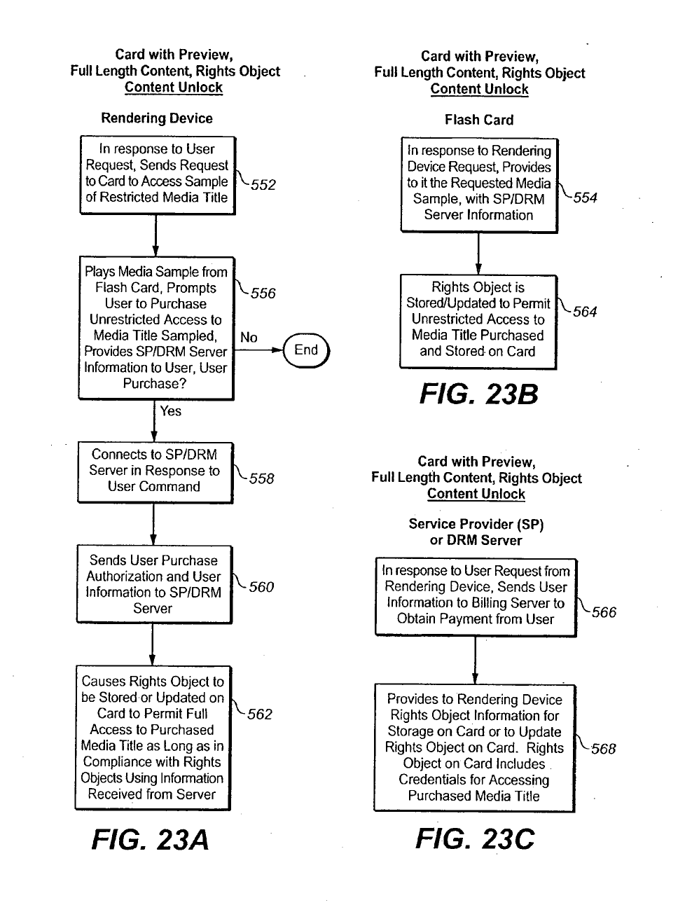

In an alternative embodiment, the full unabridged versions of the media titles cataloged in device 10″ are not already stored in device 10″. Thus after the purchaser purchases the rights for full access, such media titles would then have to be downloaded, such as in the manner described above, along with the rights object for controlling the access to such titles. The content unlocking process involving device 10″ is illustrated in the flow charts of FIGS. 23A-23C. While a flash memory card is used as the example in FIGS. 23A-23C, it will be understood that the same considerations will apply to formats other than cards and other types of non-volatile rewritable memories as well.

The rendering device, such as a terminal, responds to the End User's request to access a sample of restricted media content, such as encrypted media content cataloged in the device 10″ (Block 552). Device 10″, such as a flash memory card, responds to such request and provides to the rendering device or terminal the requested media sample (Block 554). The media sample file preferably contains information concerning the Internet address of a server from which the right to unlock can be purchased, such as the address of a Service Provider's server, as illustrated in reference to FIGS. 19A-19D or a DRM server as in FIG. 21. The rendering device plays or renders, by means of a software application operating in the device, the media sample from the flash card 10″, prompts the user to purchase unrestricted rights to the media title sampled and provides the Internet address information of the server for handling the purchasing for the user. By means of such software, the rendering device or terminal then queries the user as to whether the user wishes to purchase the rights to unlock the full unabridged media title that has been sampled (Block 556). If the user responds that he or she does not wish to purchase, the process ends. However if the user indicates a desire to purchase, the rendering device or terminal then connects to the server for handling the purchase in response to the user command (Block 558). The rendering device or terminal then sends the user purchase authorization inputted by the user and other user information to the server (SP server or DRM server) (Block 560).

As noted above, the rights object may contain content encryption keys and authentication information requiring the presentation of appropriate credentials before access to such keys can be granted, and rights and/or rules in regard to how the decrypted media files or titles can be used. In one embodiment, no rights object is stored for any one of the catalog media titles in device 10″. In such circumstances, the rights object for decrypting and controlling the catalog media titles would have to be downloaded, such as from the SP server or the DRM server.

Alternatively, device 10″ may already contain rights objects that would permit only restricted previewing of the catalog media titles. The catalog abridged media titles that can be previewed may be stored as separate files from the locked catalog unabridged encrypted media titles. Thus the preview media titles may consist of portions (e.g., 15 seconds worth) of the full media title, or a lower quality version of such title. Alternatively, the preview media titles are not stored in separate files, where only a portion or a degraded version of the locked catalog encrypted media titles is made available without restriction for preview. Preview media titles may also comprise the full length catalog media title, but where previewing is limited by either time duration or count. The above described restrictions are imposed by the rights object already stored in device 10″. Thus where the rights object of the catalog media titles is already stored in device 10″, such rights object would then need to be updated after purchase by the purchaser with the right to unlock so that the rights object after the updating would permit full access to the encrypted unabridged catalog media titles in device 10″. Thus after user purchase authorization and other user information have been sent to the SP/DRM server in block 560, the rendering device or terminal would cause (e.g., by means of the DRM agent) the rights object downloaded to be stored in the security area of device 10″ in the case where device 10″ does not already have a rights object, or would cause the rights object already in device 10″ to be updated, thereby permitting access to the media title purchased in accordance with the current updated rights object (Blocks 562 and 564).

In response to the user request from the rendering device or terminal in Block 560, a server (e.g. the SP or DRM server) responds by sending the user information to the billing server 526 of FIG. 21 to obtain payment from the End User (Block 566). The server (e.g. SP/DRM) provides to the rendering device or terminal rights object information for storage on the card or for updating the rights object on the card. The rights object includes keys and preferably information for generating credentials for accessing keys for decrypting the locked (encrypted) media title purchased. (Block 568).

In the above process, the rights object may contain the content encryption keys for decrypting the catalogue media titles. In such event, the keys are then stored in device 10″ for decrypting the titles. However, to reduce the chance of unauthorized use, access to such keys is limited to end users who have the correct credentials for accessing such keys. Such credentials may be generated on the fly by the terminal and by the device 10″ using the unique ID of the terminal as a seed value by means of a function such as hash function in both the device 10″ and the terminal. Thus, if the terminal has been authenticated by device 10″, device 10″ will also be able to generate such credentials and access to the keys is granted only when the two sets of credentials (generated by the device 10″ and the terminal) match. A similar process may be used to authenticate the device 10″ using the unique ID of device 10″. If both processes are performed, the scheme becomes a mutual authentication scheme.

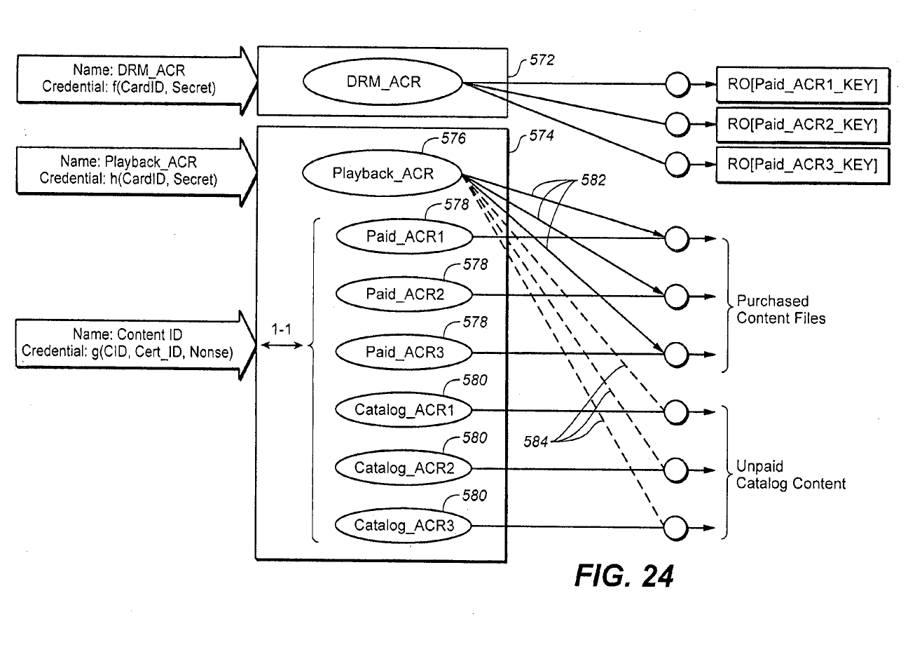

As a more secure alternative, the rights object contains not the content encryption keys themselves for decrypting the catalogue media titles, but only certain credentials for accessing such keys. For example, the credentials may be those that would enable access as governed by the ACR structure described above. Thus, where each catalogue media title has a corresponding ACR with corresponding content encryption key(s) that can be used to decrypt the title, supplying the credentials to such ACR from the rights object will enable the decryption of the title. In such event, the end user will then need to input the credentials in each of the ACRs of all the catalogue titles (as well as credentials for accessing the ACRs of paid content, if the paid content is similarly protected by the ACR structure) before such titles can be decrypted and rendered. The end user may then need to keep track of a large number of credentials. A more user friendly mechanism is described below in reference to FIG. 24.

FIG. 24 is a block diagram illustrating yet another embodiment for unlocking locked catalog media content in device 10″ using the access control records (ACRs) and delegation attribute described above. Thus the control structure in device 10″ contains two AGPs 572 and 574. AGP 572 contains the DRM_ACR. The DRM_ACR controls the rights objects for three different paid content media files. These rights objects control, for example, the limited right for moving content to personal computer libraries or to export the content to another terminal.

AGP 574 contains seven access control records, including a playback _ACR 576, three paid_ACRs 578 for controlling access to the content encryption keys of the three paid media content titles and three catalog _ACRs 580 controlling access to the content encryption keys of three corresponding catalog media titles that have not been paid for. As shown in FIG. 24, arrows 582 pointing from the playback _ACR 576 to the three paid _ACRs 578 indicate that the three paid_ACRs 578 have delegated their rights to the content encryption keys to the playback _ACR 576 so that there is no need to present credentials to the three paid _ACRs 578 in order to access the content encryption keys used for decrypting the three paid media titles controlled by the three paid_ACRs 578. Instead, by presenting the proper credentials to the playback _ACR 576, the content encryption keys for decrypting the three paid media titles can be accessed, so that it is much more convenient for the End User to have to remember only one set of credentials instead of three or more sets.

In the embodiment above, the rights object downloaded or updated contains credentials in the ACRs for accessing the keys for decrypting individual catalogue or paid media titles. As an alternative embodiment, the rights object downloaded or updated contains credentials to the DRM_ACR instead. The DRM_ACR has the permission to cause the catalog _ACRs 580 to also delegate their rights to access content encryption keys for decrypting the three unpaid catalog media titles also to the playback _ACR 576. Thus, after the rights object has been downloaded or updated, the DRM agent in either the terminal or device 10″ will access the DRM_ACR by presenting credentials from the rights object, and causes the DRM_ACR to exercise its rights to cause the delegation. In the embodiment illustrated in FIG. 24, the catalog ACRs 580 then delegate their rights to access content encryption keys for decrypting the three unpaid catalog media titles also to the playback _ACR 576, after the billing server confirms that payment has been received from the End User in Block 566 in FIG. 23C. This is illustrated by dotted lines 584 in FIG. 24. Thus after the delegation, by presenting only a single set of the appropriate credentials to the playback _ACR 576, the content encryption keys for decrypting media titles controlled by catalog _ACR 580 may be accessed as well as those for decrypting the paid media titles controlled by ACRs 578.

As illustrated in FIG. 24, and as added security, the rights object contains a secret code, instead of the credentials of DRM_ACR. The credentials of the DRM_ACR may be generated on the fly from the secret code and the ID of device 10″ using a function. The credentials of the playback _ACR may be generated in a similar manner from a secret code and the ID of device 10″ using a function. All the end user needs to input is the secret code for generating the credentials of the playback _ACR 576. Instead of ACRs, the above scheme can also be achieved using rights objects, where different rights objects controlling access to media files can contain the right to delegate the permission to access such files to a playback rights object.

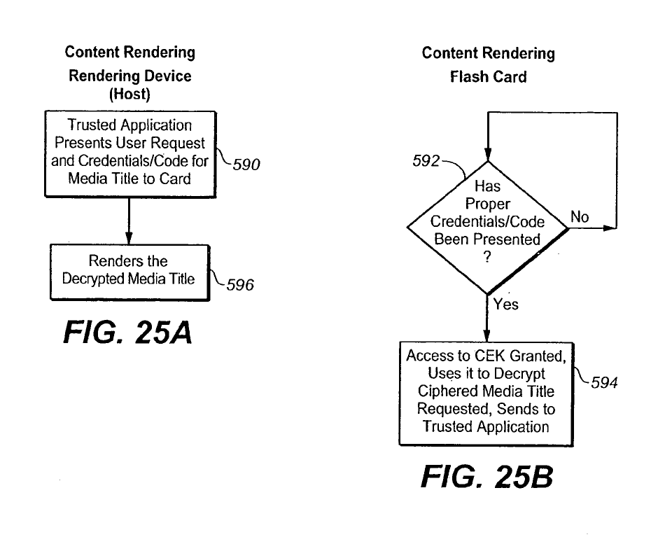

The process of content rendering is illustrated in the flow charts of FIGS. 25A and 25B. A trusted application on the rendering device or terminal presents a user request and credentials or secret code for access to a media title to device 10″ (Block 590). Device 10″ then determines whether the proper credentials or secret code have been presented to it by the rendering device (diamond 592). If the proper credentials or secret code have not been presented, device 10″ simply waits until such credentials have been presented. If the proper credentials or secret code have been presented, then access to the content encryption keys stored in device 10″ is then granted. The keys are then used to decrypt ciphered media title requested. The decrypted media title is then sent to the trusted application (Block 594). The rendering device or terminal then renders the decrypted media title (Block 596).

### Enabling Service Providers to Create Secure Environment

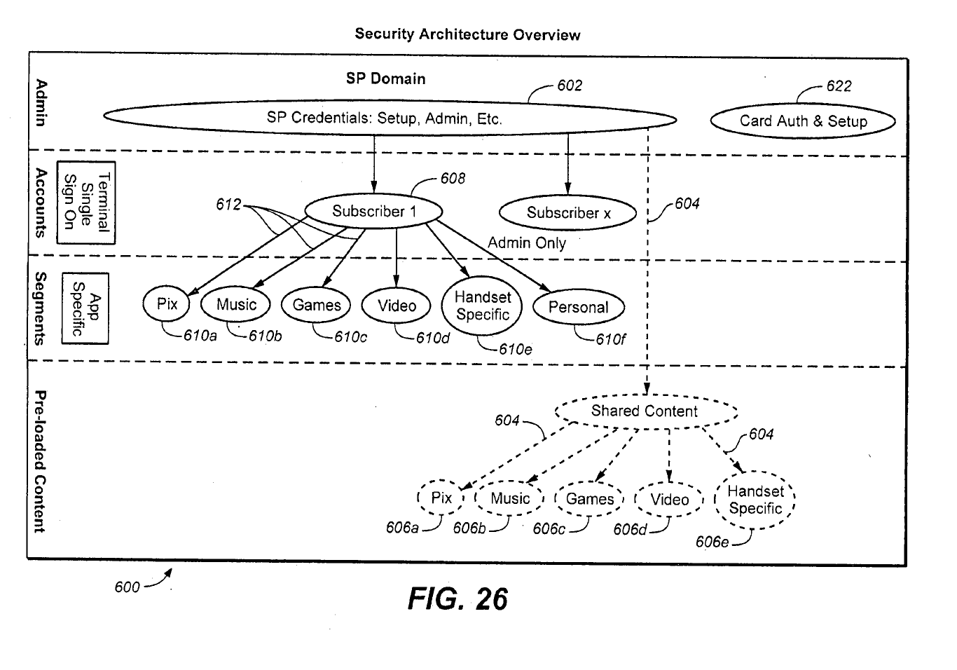

FIG. 26 is a block diagram of a security architecture or control structure in a non-volatile re-writable memory device to illustrate additional features of this invention. The security architecture 600 of FIG. 26 includes credentials of a service provider (SP) stored in a security area such as that shown in FIG. 20. SP credentials 602 points to pre-loaded media content 606 through arrow 604, content 606 including pictures 606a, music 606b, games 606c, and video 606d. Where the service provider (SP) is a MNO, pre-loaded content 606 also includes handset specific media content 606e, such as ring tones. The arrow 604 indicates that if an application operating in a terminal has the SP credentials 602, the application will be able to access the pre-loaded content 606a-606e. Thus, where the service provider SP is a mobile network operator such as Sprint or Verizon, the operator may load its credentials into cellular phone handsets issued by it. Then all such handsets may be used for accessing the pre-loaded content 606a-606e by supplying the credentials of such operator to the memory device with such pre-loaded content.

In addition to media content that is accessible by all applications with credentials of the service provider, the memory device may also store media content that is accessible only by certain subscribers. Thus, as illustrated in FIG. 26, pictures 610a, music 610b, games 610c, video 610d, handset specific information 610e, and personal media content 610f are available only to subscriber 1, or one with subscriber 1's credentials. Thus, only an application which can supply the credentials of subscriber 1 will be able to access the media content 610a-610f. Thus, if subscriber 1 wishes to access any one of the files 610a-610f, he or she would input his or her credentials by means of an application in the terminal such as a handset, and can then access any one of such files. The subscriber 1's account 608 can be an individual account, or can be a shared account within a group, such as a member account of a family account. In such event, there can be more than one set of credentials that can be used to access the files 610a-610f. When any one of the sets of credentials is transmitted to the memory device with architecture 600, the files 610a-610f can be accessed.

It will be noted that the architecture 600 enforces the policy that, before subscriber 1 even reaches the stage where the credentials of subscriber 1 are requested, SP credentials should first be presented. After the SP credentials have been presented to the memory device, the subscriber is then asked to input the credentials for subscriber 1, if the subscriber wishes to access any one of the restricted files 610a-610f.

The subscriber 1's account 608 points to files 610a-610f by arrows 612. Arrows 612 symbolize a control structure of one of the types described above, such as by means of rights objects which may include rights and/or rules for using the content in files 610a-610f. The rights objects may also include keys for decrypting the encrypted files 610a-610f. Preferably, however, the rights objects will include credentials for accessing access control records through which the content encryption keys may be obtained for decrypting files 610a-610f.

Architecture 600 may be used to store the encrypted media content accessible by multiple subscribers, where the media content accessible to one subscriber may or may not be accessible to a different subscriber. Thus, architecture 600 also includes an account for subscriber X. Although not shown in FIG. 26, media content files associated with subscriber X may be accessed only if proper credentials for subscriber X is presented to the media device containing architecture 600. In this manner, memory device 10 may be used by multiple subscribers. Each of the subscribers is able to independently access the media content associated with his or her account without fear of a different subscriber gaining unauthorized access to such content. At the same time, there can be shared content such as files 606a-606e that all subscribers may access via architecture 600 as long as they have SP credentials. There may also be partial overlap between media content files accessible to two or more subscribers. For example, certain media content files may be associated with more than one subscriber account, so that such media content file can be accessed and decrypted when the credentials of any one of the subscribers are presented to the memory device. This can be done without the subscribers having to share either their credentials or any keys.

As noted above, one possible control structure for the security architecture 600 in FIG. 26 is the access control records (ACRs) described above. Typically the ACRs for controlling CEKs for decrypting encrypted media content are created when the memory device is created, such as the ACRs shown in FIG. 24. Then when the subscriber account is created, credentials in the appropriate ACRs are supplied to the subscriber to allow the subscriber to access the CEKs.

As described above, a system ACR has the ability to create AGPs and ACRs. In general, any ACR or AGP having the authority to create ACRs may be used to create subscriber ACRs. Such ACR or AGP may be already created in device 10 when manufactured. The ACR may be created as the control structure in memory device 10 before or after any media content has been loaded into the device. Content loaded into the device may be encrypted using content encryption keys generated by or supplied to the device, where the content and encryption keys become associated and are controlled by the subscriber ACR. In such manner, the subscriber associated control structure may be used to control access to such encrypted media content.

The security architecture in FIG. 26 illustrates one avenue for media content distribution, where the memory device is bound to a particular service provider, so that it can not be used by different service providers for storing and controlling media content in the device. As an alternative security structure to that in FIG. 26, the security architecture in memory 10 may contain no SP credentials 602, so that such credentials are not necessary for accessing the content in the device. In such alternative embodiments, each of a number of different service providers may be able to create its own control structure independently of the other service providers in the same memory device. Each of the service providers may interact with the memory device without crosstalk or interference by another service provider. The system ACR of the SSA system described above pre-loaded in device 10 will assist each of the different service providers to create its own hierarchical tree in the form of AGP-ACR structures in the manner described above.

Thus, the control structures described above include the rights objects and ACRs and the associated hierarchical tree. Rights objects, as noted above, are typically created outside the memory device and are downloaded to the device. In one embodiment, such objects are managed by the DRM agent in the DRM server or the terminal, and by structures such as the DRM ACR in the memory device. ACRs and the associated hierarchical tree, on the other hand, may be structures created in the memory device and do not exist outside of it. Normally it is undesirable to export their content or features to entities outside the device. ACRs may include permissions as to how CEKs are to be used, such as for read, write or delegate functions. Rights objects, on the other hand, can specify more precisely how the CEKs and the content encrypted thereby can be used, such as by limiting the time duration in which access is allowed or number of accesses and so forth.

As another feature, software code implementing a playlist manager stored (e.g. in the security area) in the memory device may be used to register the location in a media title where the End User stops the playback or other rendering process. This allows the End User to disconnect the memory device from one terminal and connect it to another terminal and resume the play or rendering at the point where he or she stopped.

### Certificates for Authentication

One important issue that media content providers and service providers need to contend with is whether a particular memory device into which content is to be loaded is a genuine device or not. On the other hand, from the point of view of the memory device, it may also be useful or necessary to determine whether a host or terminal (or a server) attempting to store or retrieve content or rights information is genuine or not. For this purpose, the security architecture 600 also includes authentication and set up features 622, such as a certification. This is explained in more detail below.

Preferably, the control structures created by different service providers are stored in separate partitions so that each partition stores only the control structure (e.g. AGP-ACR and/or rights objects) of its corresponding service provider. Preferably, such partitions are private and hidden so that each of at least some of the partitions is accessible to the corresponding service provider of the control structures stored therein and not to other service providers. There is preferably no crosstalk between the hierarchical trees created for different service providers.

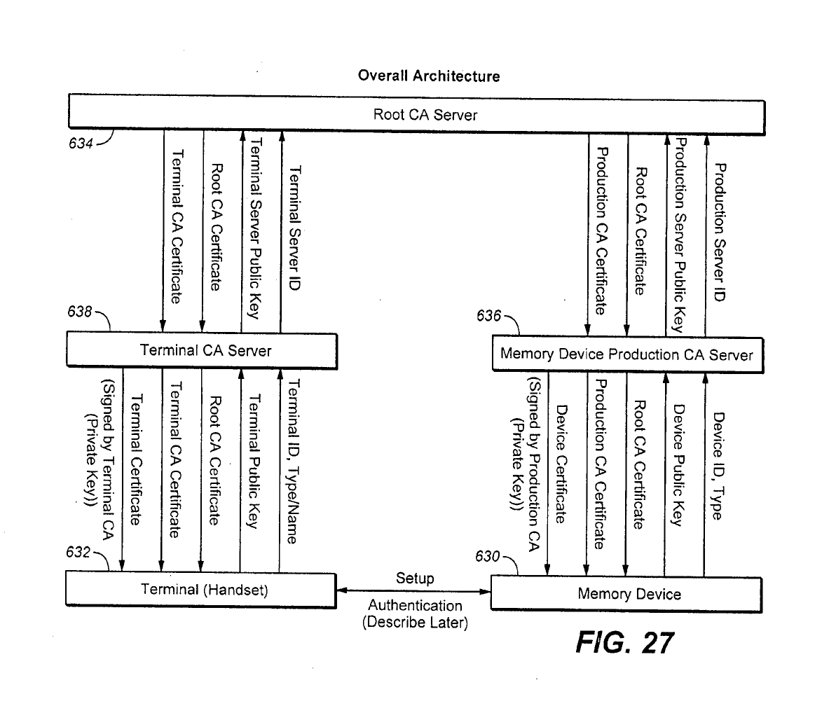

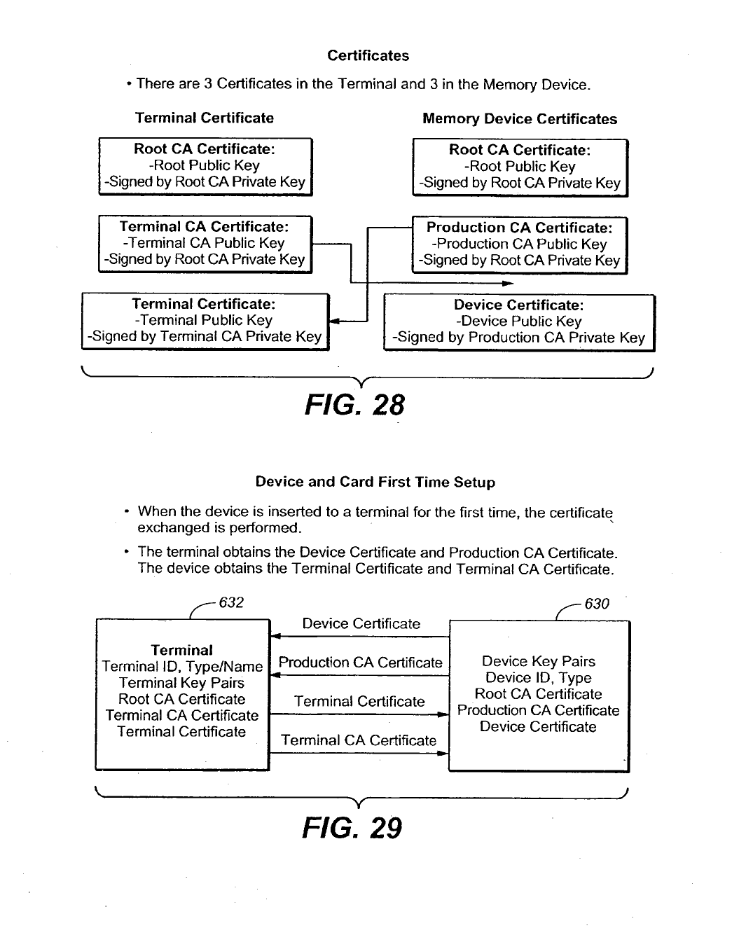

An overall architecture for mutual authentication between an end user terminal and a memory device is illustrated in FIG. 27. As shown in FIG. 27, the certification of a memory device 630 as genuine and the certification of end user terminal 632 as genuine are both derived from the authority of the root CA server 634. Device 630 is manufactured by a production facility where a production CA server 636 is located. Terminal 632 is in turn manufactured at a facility where terminal CA server 638 (which may be the same as server 634) is located. Thus, device 630 provides to server 636 the device ID, type and the device public key. Server 636 provides the production server ID and the production server public key to server 634. Server 634 provides the Root CA certificate and a production CA certificate to server 636. Server 636 in turn provides the two certificates from server 634 along with a device certificate signed by the private key of server 636 to device 630. A similar process is carried out between servers 634, 638, and terminal 632. As a result of the above-described process, terminal 632 and device 630 each contains three certificates as shown in FIG. 28.

As shown in FIG. 28, the memory device includes three certificates: root CA certificate, production CA certificate, and the memory device certificate. Since both the device 630 and the terminal 632 have the root CA certificate and root public key, this key may be used for verification that the public keys and the certificates containing these keys in the device and the terminal are genuine in the manner explained below, during the first setup process.

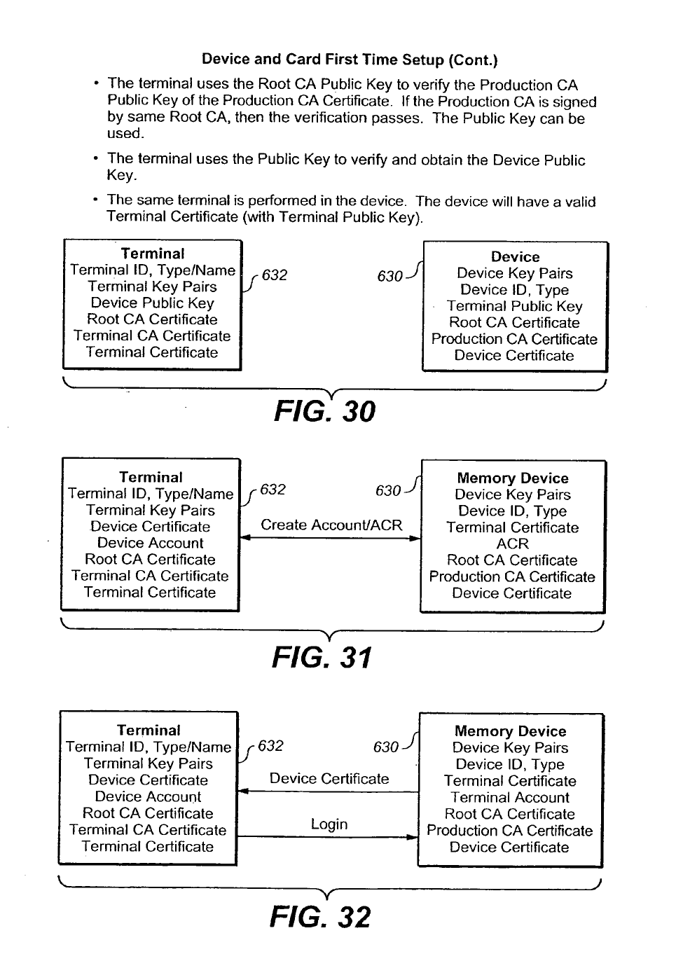

As illustrated in FIG. 29, terminal 632 and device 630 will exchange certificates the first time the device is inserted into the terminal for a setup process. The device will send the device certificate and production CA certificate to the terminal, and the terminal will send the terminal certificate and terminal CA certificate to the device. The different keys and certificates contained in the device 630 and terminal 632 are illustrated in FIG. 30.

The production CA certificate includes a production CA public key and a version of such public key which is signed (i.e. encrypted) by the root CA private key. The terminal 632 can verify whether this production CA certificate is genuine by using the root public key in its possession to decrypt the encrypted production CA public key and compare the result with the production CA public key in the production CA certificate received from device 630. If they match, this indicates that the production CA certificate received has not been tempered with and is genuine. Terminal 632 can then use the production CA public key so confirmed to decrypt the encrypted version of the Device public key and compare the results with the device public key in the device certificate received from device 630. If they match, this indicates that the device certificate received has not been tempered with and is genuine. Device 630 can perform a similar process to verify that the certificates received from the terminal are genuine and have not been tempered with. It will be evident from the above that the more levels of keys and certificates that are utilized, the more secure will be the system. Three levels are used in FIGS. 27-32. Obviously, if a higher or lower level of security is desired, the above scheme can be altered accordingly.

After the device and the terminal have performed the mutual authentication process above, the terminal will create an ACR in the device 630 as illustrated in FIG. 31 using an ACR that has been created in the device during manufacturing. This ACR created will contain the root CA certificate with the root public key, so that the next time the terminal is connected with the device, the device will verify using the root public key that the terminal certificate provided by the terminal is genuine in a process similar to that described above. If the terminal certificate provided by the terminal is verified to be genuine, then the memory device will allow the terminal to access content according to the permissions in the ACR.

As illustrated in FIG. 32, the next time the memory device is connected to the terminal, the terminal will log in and send its certificate to the device. The device will then perform the verification process described above. As an option, the memory device 630 also sends its certificate to the terminal 632 for verification as illustrated in FIG. 32.

The certificates stored in the device 630 can also be used for an authentication server, such as any one of those shown in FIGS. 19A-19D to check whether the device is genuine. If the server also has the root CA certificate and root public key in the certificate, this key may be used in a manner similar to that described above to verify that the device is genuine or a counterfeit. The device 630 can also verify whether the server is genuine by a similar process. The authentication server may also transfer the root CA certificate and the software for performing the checking to a different server, such as the server for the service provider, so that the service provider server can perform the verification process instead. The process in FIGS. 19A-19D would then be simplified in that the service provider server can then perform the functions of the authentication server as well.

### Preloaded Content Packaging

The memory device 10″ of FIG. 22 is preloaded with paid media content such as songs, as well as catalog media content which is unpaid. Such catalog media content may comprise encrypted full-length and high quality versions, as well as previews of such versions. Stored in device 10″ may also be promotional items as well as various applications. As described above in reference to FIG. 20, memory device 10″ may comprise a number of different areas, including a content area and a security area. Preferably, the security area is accessed only during device production in a secure production facility. For example, rights objects and AGP/ACR structures and other digital rights management solutions are stored in the security area of the device 10 or 10″ at the secure production facility. Content encryption keys may be loaded to the secure area at the secured facility, or may be generated after production by the device itself.

Content such as operator content and other secured content in the content area typically has large files, such as video files. The secure facility for loading secure data in the security area may not have the capability to load a large number of large files in volume production. For this reason, it may be desirable for locked content as well as unlocked content to be loaded in a non-secure area of production facility. Since the locked media content is typically encrypted, such content may be sent to the non-secure facility in an encrypted form to reduce the chance of unauthorized exploitation. Each memory device has a unique identification such as serial number which may be sequential. Thus, it may be possible to first store security related data and objects in the security area before the device is turned over to a non-secure facility for loading the encrypted media content as well as non-encrypted content. Since the data loaded into the security area may include control structures for controlling the use of the media content stored in the content area, first loading these control structures into the security area before the encrypted content is loaded provides an additional security to prevent unauthorized exploitation of the media content.

The keys used to encrypt content in each of the memory devices manufactured may be different from the keys preloaded in any other device. If this is indeed the case, a hacker who is able to obtain the encryption key in one memory device will not be able to access the content stored in any other memory device. However, generating and loading a large number of different content encryption keys into each device may be cumbersome. As a compromise, the same set of keys may be loaded into a batch of memory devices so that they will have the same set of keys. Therefore, if the set of keys in one of the memory devices in a batch has been obtained in an unauthorized manner, the media content stored in such batch of memory devices may become accessible without authorization. The person who has obtained such set of keys will, however, not be able to access the media content stored in a different batch of memory devices since the media content in such devices would be encrypted by a different set of keys than the one obtained illegally.

Thus, if 50,000 memory devices are to be produced, the 50,000 devices may be divided into 1,000 sets, each including 50 memory devices, with each device in the set loaded with one of 50 different sets of keys. Thus, the 50,000 devices are divided into 50 batches, each batch of 1,000 devices will be loaded or will use the same set of keys. For example, the 50 sets of keys may be denoted as KOmn where m ranges from 1-20 for a maximum of up to 20 purchased media titles, such as soundtracks and n goes from 1-N where N is 50 in this case. N sets of keys KPIn are also provided where 1 may range from 1-50 for a maximum of 50 unpaid media titles such as soundtracks and n ranges from 1-N. This sets of keys KPIn should be transmitted securely to the right issuer server for issuing rights objects when these tracks are being purchased.

Also at the secure facility, the content encryption keys KOmn for the purchased titles or tracks are packaged into N sets of objects for adding the business rules such as unlimited play and three exports, for example as described above. The N sets of rights objects (one for each purchased media title) may be denoted as ROmn where m ranges between 1-20 for a maximum of 20 purchased media titles and n ranges between 1 and N. The N sets of rights objects may be securely transferred to the secure facility. During production, the unique serial number of the memory device may be used to determine which one of the 50 sets of rights objects is to be load into the cart: RO1n, RO2n, . . . R0mn, where m is may be 20 for a maximum of up to 20 purchased media titles. These 20 rights objects may be loaded into each memory device in the nth sets or batch of 1,000 memory devices, where n is determined by the sequential portion of the memory device serial number divided by 1,000 (i.e. integer portion of memory device serial number/1,000+1). For example, if the memory device serial number is 5, the n is of the value 1. Of the serial number is 1,200, the n would be 2. If the serial number is 35870, n would be 36.

The purchased media titles (a maximum of 20) may be encrypted into N sets of encrypted files COmn, where m ranges from 1-20, and n ranges between 1-N. After the up to 50 catalog media titles are obtained, these titles would be encrypted as files PCLR1, PCLR2, . . . . PCLRL where L is up to 50. From the up to 50 catalog media titles, a 15 second video snippets or a low quality version of each of such titles may be produced and are labeled as: SNIP1, SNIP2, SNIPL, where L is up to 50. Then the full length catalog media titles are encrypted into N sets of encrypted files: POIn, where 1 ranges from 1-L and n ranges from 1-N. The N sets of encryption keys for the catalog media title files are sent to the rights issuer. The master copy for content loading will then contain the following:

(1) N sets of encrypted purchased media titles COmn, where m ranges from 1-20 and n ranges from 1-N.

(2) One set of preview snippets of the catalog media titles, which snippets have not been encrypted and will be the same across the N sets of media devices: SNIP1, SNIP2, . . . . SNIPL where L is up to 50.

(3) N sets of encrypted catalog media titles corresponding to the preview snippets, that are encrypted with different content encryption keys across N sets of memory devices: POIn, where 1 ranges from 1-L and n ranges from 1-N.

(4) One set of all other promotional contents, such as computer clips, photos, ring tones.

At the non-secure content loading facility, such as a third party contractor facility, the master copy and content loading script may be used to load the content to the memory devices. The content loading script will read the memory device serial number first, and based on the serial number, calculate the batch or set number between 1 and N. Then based on this set number n, the content loading script will read the nth set of the purchased media title files: CO1n, CO2n, . . . COmn, where m is the number of media titles in the purchased media content. The content loading script will also read the nth set of the catalog media title files PO1n, PO2n, . . . POLn, where L is the number of catalog media title files for including on the devices. The set of preview snippet files and the set of promotional items in post application are also loaded onto each memory device. The content loading script will then write the above selected files into the content public area of the memory device illustrated in FIG. 20.

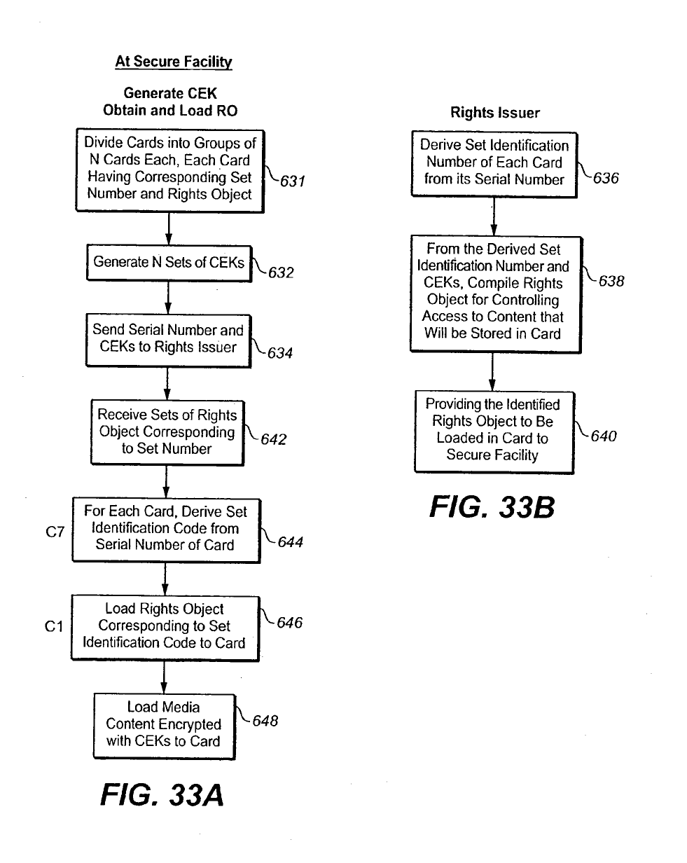

The process of generating the keys for the prepaid content and loading of the titles; and issuing of rights objects by the rights issuer is illustrated in reference to FIGS. 33A and 33B. At the facility, the devices or cards to be loaded are divided into groups having N devices or cards, each of the N devices in each group having a different set number and corresponding set of keys and rights object (block 631), where the set number is derivable from the serial number of the device (block 632). N sets of content encryption keys are generated and sent to the rights issuer (block 634). The rights issuer derives the set identification number of each memory device such as a memory card from its serial number. From the derived set identification number and the N set of keys received, rights objects for controlled access to the content is compiled, identified and sent to the facility for loading (blocks 638, 640). These are received at the facility for loading (block 642). For each device such as a memory card, the set identification number is derived at the facility from its unique serial number, and the corresponding set of keys and rights object identified (blocks 644). The corresponding rights object is then loaded into the device such as a memory card. The purchased media titles are encrypted at the secure facility, and a master copy sent to a contractor's facility for loading of the encrypted titles (blocks 646, 648).

As noted above, the DRM agent in either the memory device and/or the terminal may be used to handle the above actions for the device and/or terminal.

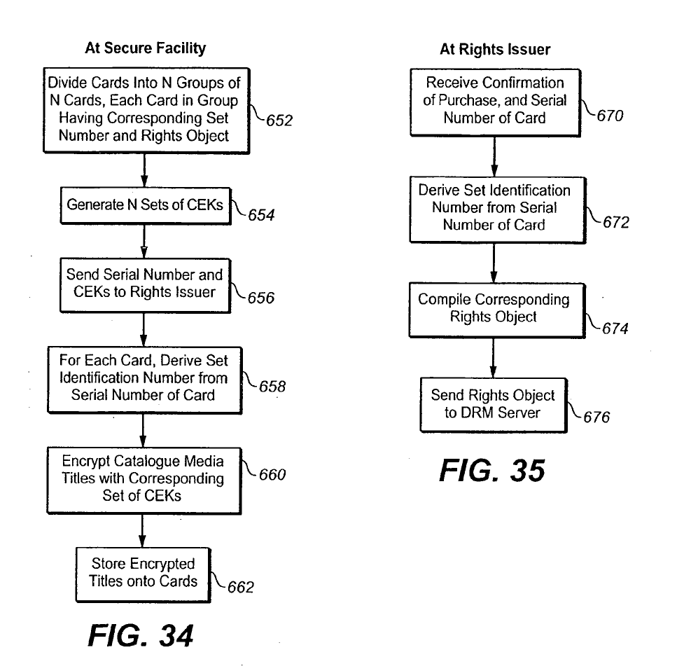

The process of generating the keys for the catalogue content and loading of the titles and issuing of rights objects by the rights issuer is illustrated in reference to FIGS. 34 and 35. At the facility, the devices to be loaded are divided into groups having N devices or cards, each of the N devices in each group having a different set number and corresponding set of keys and rights object, where the set number is derivable from the serial number of the device (block 652). Thus, N sets of CEKs for the catalogue media titles are generated by the secure facility, and the CEKs and device ID numbers are sent to the rights issuer (blocks 654, 656). For each device such as a memory card, the set identification number is derived from its unique serial number, and the corresponding set of keys identified (blocks 658). The catalogue media titles are then encrypted using the corresponding set of keys identified (block 660). The catalogue media titles are then stored in the device such as a memory card (block 662).

During the purchasing transaction and in reference to FIG. 35, once the purchase by the end user has been confirmed (block 670), the set identification number is derived from the device serial number (block 672) by the rights issuer, and the appropriate rights object is compiled using the set number and the CEKs received from the facility in block 656 (block 674). The rights issuer provides the corresponding rights object to the secure facility (block 660). When the end user is purchasing catalog media titles, the DRM agent will send a serial number of the memory device and the ID of the media title purchased to the rights issuer server (block 670). The rights issuer server then calculates the set number of the memory device based on the serial number of the memory device (block 672). The rights issuer should already have the N sets of encryption keys for the catalog media title files. Based on the set number and the media title ID, the rights issuer will be able to issue the correct rights object with the corresponding content encryption keys to be downloaded to the memory device after the purchase. (block 676)

Memory with Other Content as Avenue for Media Content Distribution

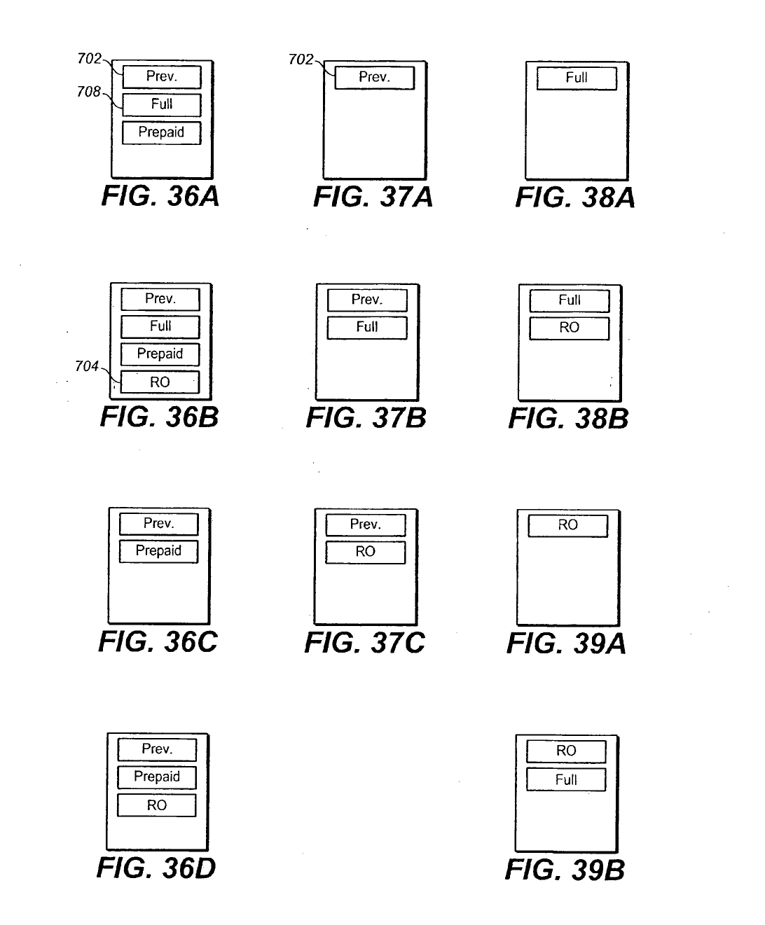

The case of memory devices with encrypted media titles and previews of such titles is described above. These types of devices are illustrated in FIGS. 36A-36D, where the devices also include prepaid content. In these figures, PREV means preview content comprising media content that has been abridged (e.g. a portion or lower quality version); FULL means the unabridged encrypted version of PREV; RO means rights object of PREV. PREPAID means content that has been paid for when acquiring the memory device. For simplicity, the rights object(s) for prepaid content has been omitted from the figures.

Alternatively, the memory devices such as device 10 can store other types of content, as illustrated in FIGS. 37A-37C, 38A, 38B, 39A and 39B. As shown in FIG. 37A, the device may store only PREV, or both PREV and FULL as shown in FIG. 37B. The device can also store PREV and RO as in FIG. 37C. Thus, in FIGS. 37A-37C, the device stores PREV in all configurations.

As another alternative, the memory devices such as device 10 can store FULL in all configurations, as in FIGS. 38A and 38B. In FIG. 38B, it also stores RO.

As yet another alternative, the memory devices such as device 10 can store RO in all configurations, as in FIGS. 39A and 39B. In FIG. 39B, it also stores FULL.

In all of the configurations in FIGS. 37A-37C, 38A, 38B, 39A and 39B, PREPAID and the rights object(s) therefor are not shown, but can be included if desired.

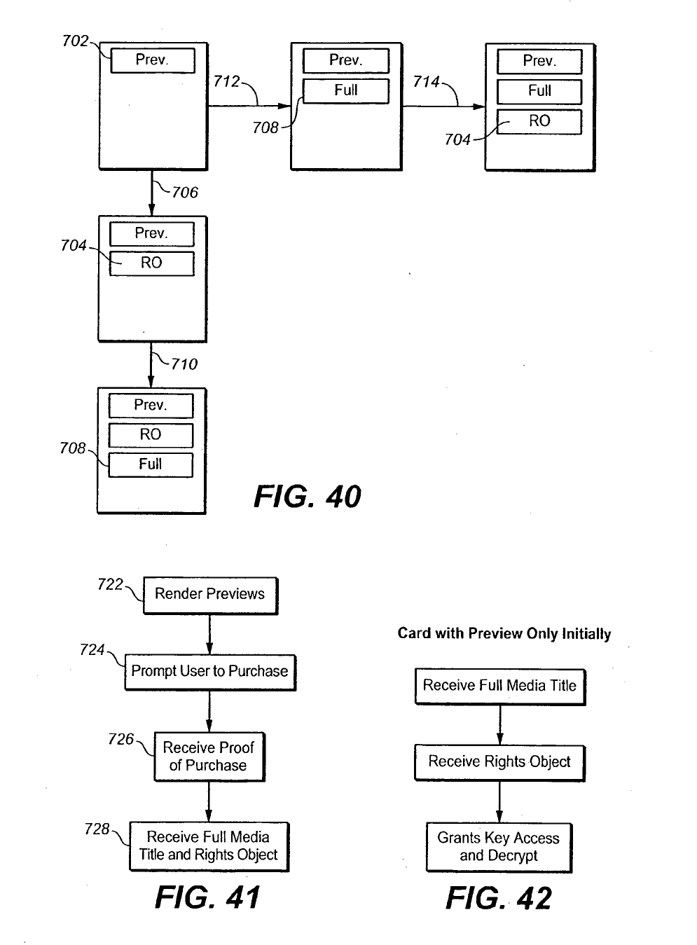

Thus, as shown in FIGS. 37A and 40, device 10 may be loaded only with preview content, such as the snippets or lower quality versions of the media title. Such titles are indicated at 702. After the end user purchases the right to view the unabridged version of the media titles that has been previewed by means of memory device 702, the rights object 704 may be downloaded after purchase of content 702 as indicated by arrow 706 in FIG. 40. Armed with the rights object, the end user will have the right to download the unabridged version 708 (FULL) of the media title that has been previewed. The transformation from a device without the unabridged media title to one that does is indicated by arrow 710 in FIG. 40. Alternatively, the end user may download the full and unabridged version (FULL) of the media title 708 first, as indicated by arrow 712 in FIG. 40. At this point, however, the end user still does not have the right to access the full media title 708, since such title is encrypted and access to the content encryption key necessary to decrypt such title has been provided to the end user. But after the end user made the purchase, the end user will have the right to download the rights object 704 as indicated by arrow 714 in FIG. 40.

The process of media content distribution using the flow in FIG. 40 is somewhat similar to that in FIG. 23 and is shown in FIG. 41. Thus, the preview content 702 enables the user to first preview the catalog media titles. Memory device thus renders PREY and then prompts the end user, through an end user terminal, to purchase the catalog media title previewed (blocks 722, 724). After purchase has been received, then the full media title and rights object are supplied to the memory device for storage (blocks 726, 728). Thereafter, the end user will be able to access the media title purchased by decrypting the title and render it. In FIG. 42, the preview content 702 enables the user to first preview the catalog media titles. The full media title is downloaded followed by receiving the rights object (this order can be reversed) after the purchase. Keys can then be used to decrypt the full title for rendering.

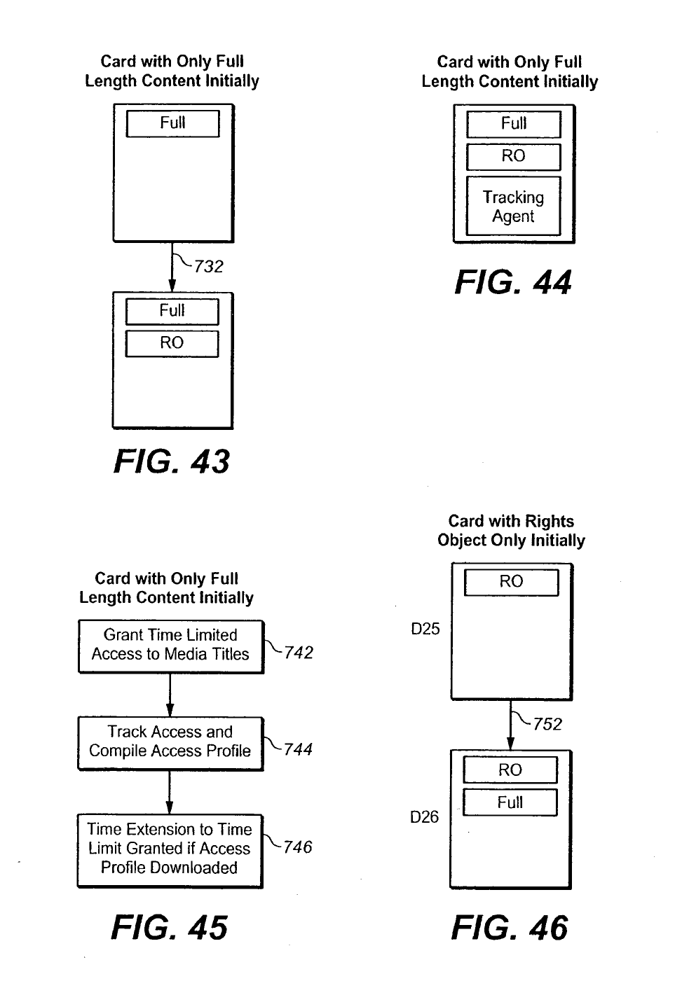

Alternatively, memory device 10 may be distributed only with the full encrypted and unabridged media titles as illustrated in FIG. 38A. If the end user has already purchased the rights to such media titles (FIG. 38B), then the memory device will also be provided with the rights object and access to the necessary content encryption keys for decrypting the media titles. If, however, that the memory device for the full media titles is distributed prior to purchase, the end user will have to purchase the rights to access. After the purchase, the appropriate rights objects are downloaded (arrow 732 in FIG. 43) to provide access to the content encryption keys necessary for decrypting the media titles purchased.

As a variation of such avenue of content distribution, a memory device with the full unabridged but encrypted media titles may be stored along with the rights object which permits only restricted viewing or access of such media titles. Also stored in the device is a tracking agent that tracks the usage pattern of the end user and compiles a user profile. See FIG. 44. The restriction may impose a time duration restriction, or the number of times the media title may be accessed (block 742 in FIG. 45). When the user renders the title, the access is tracked and the user access profile is compiled (block 744 in FIG. 45). At the expiration of the time duration or the count, the end user will no longer be able to access the media title, unless the end user then connects the memory device to a server. When the memory device is connected to a server through a host or terminal, such user profile is then downloaded to the server for purposes such as market research. After the access profile has been downloaded, the rights object may be modified or updated to permit the end user an extended time duration or count for accessing and enjoying the media titles on the memory device (block 746 in FIG. 45).

As yet another possible avenue for media content distribution, memory device 10 may be distributed with only the rights object loaded shown in FIG. 39A. Such memory devices must be purchased and it functions similar to a prepaid service card such as a SIM card for phone service. The rights object will permit the end user to download the full unabridged media titles for enjoyment (block 752 in FIG. 46). The rights object may permit the end user to download a large number of media titles. Thus after the end user has enjoyed a number of the downloaded titles, it is possible then for the end user to delete these from the memory device and then download the same titles later. In this manner, the end user is not restricted to the storage capacity of the memory device, but can repeatedly download and delete media titles from the memory device.

Backup and Reload Control

In some circumstances, it may be desirable to have the capability to back up the contents on a non-volatile memory device such as a flash card, including not only the media content that may be present, but also any rights object that controls access and what can be done with the content once it is accessed. However, if this is done without adequate control, this may provide a back door by which the control using the rights object can be circumvented. For example, if the rights object permits the making of a limited number of copies such as three copies, the rights object will keep track of the number of copies made. Once the set limited number of copies have been made, then the rights object will prohibit any further copying. This restriction can be avoided if a back up copy of the rights object can be made to a storage region prior to copying and restored to the memory device after three copies have been made. By restoring the original rights object that allows three copies, the user can again make three more copies. This process can obviously be repeated, so that the restriction in the rights object can be circumvented altogether. The storage region can be in the same device from which a back up copy of the rights object is made, or in a different device.

To prevent this from happening, the rights object is stored in a protected partition, such as those described above in reference to FIGS. 2-4. In order to access such protected partition, an application such as one on a host will need to supply the appropriate predetermined credentials to the memory device, before access can be granted. The end user normally will be able to access the rights object for the purpose of rendering or playing the content controlled by the rights object. In order to prevent the end user from accessing the rights object for the purpose of back up and restoration, the end user credentials permit the end user to only able to read the rights object from the partition, but not to back up and restore the rights object in the partition. In order to back up and restore the rights object, credentials different from those available to the end user are used. Only applications with such credentials may back up and restore the rights object in the partition. The rights object is restored to a protected partition, so that the restored rights object will again be effective in controlling access to the corresponding content, such as by means of the two different sets of credentials: one set permitting only the reading of the rights object, and the other permitting back up and restore.

Preferably, the rights object is deleted from the memory device after the rights object has been backed up and stored in a back up storage region. After the rights object is restored to the memory device, it is preferably deleted from the back up storage region.

The above features can be applied to a wide variety of non-volatile memory storage devices, where a secure memory area is provided in addition to a non-restricted memory area.

As an alternative to the above scheme, only certain authorized applications having a first set of credentials are allowed to perform back up and restoration functions, while other applications having a second set of credentials different from the first set can only read the rights object. Such authorization can be controlled either by the memory device, or externally by a server, for example, through a registration process. It is expected that only applications with DRM and/or CPRM capabilities will have the authority to modify, update, or erase, and/or back up and restore the rights object. This alternative scheme may be useful whether or not a secure memory area is provided.

As noted above, the rights object may permit the making of a limited number of copies such as three copies. In order to enforce such rule, the rights object will keep track of the number of copies made. Thus, when an application copies the rights object, the rights object that remains on the memory device will need to be updated to keep track of the number of copies, if any, that are still permitted after a copy has been made. Moreover, the rights object that is copied will need to be altered during the copying so as to reflect accurately, whether further copies can be made from such copy. Thus, if the end user wishes to allow further copies to be made from such copy, it may be preferable to modify the rights object copied to make this possible. For example, the rights object permits a total of n copies to be made from an original, where n is a positive integer. The rights object copied may specify that a total of m copies may be made from the copied rights object, where m is zero or a positive integer less than n. In such event, the rules in the original rights object will be updated to permit only (n-m) copies to be made from the original. Thus, the rights object (the original as well as the copied) will include the count or number of copies that can be made from it, and also the requirement that the copy count will need to be modified accordingly upon further transfers. When no more copies can be made from such object, this count or number will become zero.

Rights object for controlling media content may specify the right for unlimited rendering or plays. Alternatively, the number of rendering or plays may be limited as well. If this is the case, the rights object will include the count or number of rendering or plays that can still be made.

As in the case of backup and restoration, the credentials needed to access the rights object for the purpose of modifying, updating or deletion are different from those needed for read only functions. The credentials needed to access the rights object for the purpose of modifying, updating or deletion may be the same as those for backup and restoration.

In some embodiments, if an attempt is made to make a copy of such object (i.e. an object from which a copy cannot be made), this will result in such object being deleted from the memory device (or other storage) when the copy is made to another device, as specified in the rights object, for example. After the deletion, the content cannot be accessed anymore, for rendering, play back or any other purpose. In other embodiments, if an attempt is made to make a copy of such object, the right for limited or unlimited rendering or plays will be updated to indicate that no rendering or plays can be made, or access to the rights object can simply be blocked altogether except for limited purposes such as diagnosis, or failure analysis.

The rights object is preferably encrypted by means of a key (preferably performed in device 10), and the proper credentials presented to the memory device will cause such key to become available for reading only or for writing (which means allowing deletion, modification or updates, backup and restoration) in the manner as described above. Thus, prior to any copying or modification, the rights object is first decrypted. Then any modification or deletion can be performed in the manner described above and the rights object encrypted. The crypto-engine 40 may be used to perform the encryption. If encryption of the rights object is not desired, a bypass path (not shown in FIG. 1) without any cryptographic operation on the data stream, as if the Crypto-Engine 40 is not present and the HDMA and FMDA are connected directly along this bypass path to BRAM 38 through arbiter 36.

Thereafter, the rights object can be copied if copying is desired and permitted by the rules in the rights object. However, to make this a secure process, the decrypted rights object to be copied is encrypted using a session id or key and transmitted to another storage device. At such another storage device, the rights object is decrypted using the session id or key, and then encrypted again using yet another key (which can be from the another storage device, or another source) and stored in the another storage device. This process can also be carried out for the rights object that is backed up and restored.

The above features can be applied to a wide variety of non-volatile memory storage devices, whether or not a secure memory area is provided in addition to a non-restricted memory area.

While the invention has been described above by reference to various embodiments, it will be understood that changes and modifications may be made without departing from the scope of the invention, which is to be defined only by the appended claims and their equivalent. All references referred to herein are incorporated herein by reference. Thus, while some of the embodiments are illustrated herein by reference to flash memories in the form of cards, the invention may also be applicable to other types of memories whether these are in card form or not, such as magnetic disks, optical CDs, as well as all other types of rewrite-able non volatile memory systems. The steps or actions described above may be implemented by means of software code (e.g. application software) stored in the memory devices and/or the terminals or host devices and/or servers described above.

What is claimed is:

1. A method for distributing media titles by a non-volatile memory device, the method comprising:
performing the following in a non-volatile memory device:
receiving a request and a credential from an entity to access an encrypted media title stored in a first memory area in the non-volatile memory device, wherein access to the encrypted media title is controlled by control information stored in a second secure memory area in the non-volatile memory device, the control information comprising information on an account having a corresponding credential, wherein the account is associated with the encrypted media title;
checking the credential received from the entity against the account credential; determining whether the requested encrypted media title should be accessible; and
decrypting the requested encrypted media title and supplying the decrypted media title to the entity when the credential presented by the entity matches the account credential.

2. The method of claim 1, wherein access to the encrypted media title is associated with and controlled by a service provider, wherein the control information further comprises identification information for identifying the encrypted media title as controlled by the service provider, the method further comprising:
checking the credential received from the entity against the identification information to determine whether the encrypted media title should be accessible to the entity; and
decrypting the requested encrypted media title and supplying the decrypted media title to the entity when the credential received from the entity corresponds to the identification information.

3. The method of claim 2, wherein the credential presented by the entity comprises the identification information of the service provider.

4. The method of claim 2, wherein the account is associated with a set of encrypted media titles and the identification information is associated with an account, wherein the encrypted media title is decrypted and supplied to the entity when such encrypted media title is determined to be within the set and when the credential received from the entity corresponds to the identification information associated with the account.

5. The method of claim 4, wherein the account is associated with a family of end users, the identification information of the account comprises identification information for the family of end users, and wherein the checking comprises checking whether the credential received from the entity comprises identification information of any one of the family of end users.

6. The method of claim 4, wherein the account is associated with an individual end user, the identification information of the account comprises identification information for the individual end user, and wherein the checking comprises checking whether the credential received from the entity comprises identification information of the individual end user.
